(19) United States
(12) Patent Application Publication
(10) Pub. No.: US 2015/0127343 A1
(43) Pub. Date: May 7, 2015

(54) MATCHING AND LEAD PREQUALIFICATION BASED ON VOICE ANALYSIS

(71) Applicant: Jobaline, Inc., Kirkland, WA (US)

(72) Inventors: Miki MULLOR, Sammamish, WA (US); Luis J. SALAZAR G., Kirkland, WA (US); Ying LI, Bellevue, WA (US); Jose Daniel Contreras LANETTI, Renton, WA (US)

(21) Appl. No.: 14/532,600

(22) Filed: Nov. 4, 2014

Related U.S. Application Data
(60) Provisional application No. 61/899,824, filed on Nov. 4, 2013.
(60) Provisional application No. 62/045,957, filed on Sep. 4, 2014.
(60) Provisional application No. 62/064,849, filed on Oct. 16, 2014.
(60) Provisional application No. 62/072,237, filed on Oct. 29, 2014.

(51) Int. Cl. G10L 17/04

(52) U.S. Cl. CPC G10L 17/04
USPC 704/244; 704/246

(57) ABSTRACT

A computing device may perform a feature identification of a received voice segment to recognize physical characteristics of the voice segment. The device may also determine paralinguistic voice characteristics of the voice segment according to the physical characteristics of the voice segment. The device may also indicate a match status of the voice segment according to a comparison of the physical characteristics and the paralinguistic voice characteristics of the voice segment to desired characteristics of matching voice segments.

### CROSS-REFERENCE TO RELATED APPLICATIONS

This application claims the benefit of U.S. Provisional Application No. 61/899,824, filed Nov. 4, 2013, of U.S. Provisional Application No. 62/045,957, filed Sep. 4, 2014, of U.S. Provisional Application No. 62/064,849, filed Oct. 16, 2014, and of U.S. Provisional Application No. 62/072,237, filed Oct. 29, 2014, the disclosures of which are hereby incorporated in their entirety by reference herein.

### TECHNICAL FIELD

The present disclosure relates to an advertising platform for generating qualified leads using interactive advertising units to facilitate lead validation and matching with lead requests, and more specifically to matching and lead pre-qualification based on predicted human listener emotion elicited by the paralinguistic aspects of a speech segment.

### SUMMARY

One or more embodiments of the present disclosure are directed toward a voice analyzer computing device. The voice analyzer may perform a feature identification of a received voice segment to recognize physical characteristics of the voice segment. The voice analyzer may also determine paralinguistic voice characteristics of the voice segment according to the physical characteristics of the voice segment. The voice analyzer may also indicate a match status of the voice segment according to a comparison of the physical characteristics and the paralinguistic voice characteristics of the voice segment to desired characteristics of matching voice segments.

One or more embodiments of the present disclosure are directed towards an interactive digital advertising system and method. The system may include an advertising component for generating qualified leads in response to a lead request. The advertising component may be configured to receive the lead request including user-selected pre-screening inquiries and generate an interactive advertising unit for engaging responders to an advertising message. The advertising unit may interact with responders based at least in part on the selected pre-screening questions to collect responder information. The advertising component may use responder information to evaluate and validate the responders based on criteria defined by a lead requestor. The advertising component may score responders based on interactions with the advertising unit and lead requestor criteria and identify potential matches with lead requestor offers or services in real-time. The advertising component may further qualify leads based paralinguistic aspects of voice responses to the interactive advertising units. The qualified leads generated by the advertising component may be offered anonymously to the lead requestor for purchase. The advertising component may reveal at least a lead's identity and contact information upon purchase by the lead requestor.

### BRIEF DESCRIPTION OF THE DRAWINGS

FIG. 1 is a simplified, exemplary network diagram of a digital advertising system, in accordance with one or more embodiments of the present disclosure;

FIG. 2 is a simplified, exemplary block diagram of the digital advertising system, in accordance with one or more embodiments of the present disclosure;

FIG. 3 depicts an exemplary web form for submitting a lead request, in accordance with one or more embodiments of the present disclosure;

FIG. 3B depicts an exemplary web form for specifying paralinguistic voice characteristics for a lead request, in accordance with one or more embodiments of the present disclosure;

FIG. 4 depicts an exemplary online screen that may be displayed once a lead request has been submitted, in accordance with one or more embodiments of the present disclosure;

FIG. 5 depicts an exemplary interactive advertising unit, in accordance with one or more embodiments of the present disclosure;

FIG. 6 depicts another view of the exemplary interactive advertising unit from FIG. 5, in accordance with one or more embodiments of the present disclosure;

FIG. 7 depicts yet another view of the exemplary interactive advertising unit from FIG. 5, in accordance with one or more embodiments of the present disclosure;

FIG. 8 depicts an exemplary view of a social networking site including a message post requesting endorsements, in accordance with one or more embodiments of the present disclosure;

FIG. 9 depicts an exemplary view of a browser for viewing leads, in accordance with one or more embodiments of the present disclosure;

FIG. 10 depicts an alternative view of a browser include a full lead profile post-purchase, in accordance with one or more embodiments of the present disclosure;

FIG. 11 is a simplified, exemplary flow diagram illustrating a method for generating and presenting leads, in accordance with one or more embodiments of the present disclosure;

FIG. 12 is a simplified, exemplary block diagram of a number of adaptive advertising units, in accordance with one or more embodiments of the present disclosure;

FIG. 13 is a simplified, exemplary flow diagram illustrating a method for adapting interactive advertising units, in accordance with one or more embodiments of the present disclosure;

FIG. 14 is simplified, exemplary system architecture diagram of a digital advertising platform, in accordance with one more additional embodiments of the present disclosure;

FIG. 15 is a simplified, exemplary flow diagram depicting a process for generating qualified leads in an online job recruitment advertising platform, in accordance with yet one more additional embodiments of the present disclosure;

FIG. 16 is a simplified, exemplary block diagram showing various components of a voice analyzer module, in accordance with one or more embodiments of the present disclosure;

FIG. 17 is a simplified, exemplary diagram of using various sources of declared and observed information to generate potential matches using a matching engine, in accordance with one or more embodiments of the present disclosure;

FIG. 18 is a simplified, exemplary diagram illustrating a sound wave pattern of a high energy speaker in comparison with a natural conversational sound pattern, in accordance with yet one more additional embodiments of the present disclosure;

FIG. 19 is a simplified exemplary diagram of a distribution of voice segment length for the collection of voice segments, in accordance with one more additional embodiments of the present disclosure;

FIGS. 20A and 20B are simplified exemplary diagrams illustrating two sample voice segments from job applicants for an interview prompt and their corresponding spectrograms, in accordance with one more additional embodiments of the present disclosure;

FIG. 21 is an exemplary plot illustrating the clustering of speech clips based on maximum dB over time per frequency, in accordance with one or more embodiments of the present disclosure;

FIG. 22 is an illustration of exemplary, simple-to-use interfaces for collecting input regarding how specific voices make individuals feel for use in scientifically classifying datasets of voice records based on subjective characteristics, in accordance with one or more additional embodiments of the present disclosure;

FIG. 23 illustrates an example verification of voice samples by listeners for consistency, in accordance with one more additional embodiments of the present disclosure;

FIG. 24 shows a distribution of the predicted scores on voice segments by a model, in accordance with one more additional embodiments of the present disclosure;

FIG. 25 shows a histogram of bucketization by an alternate model to that illustrated in FIG. 24, in which scores for the voice segments are bucketized according to the prediction scores, in accordance with one more additional embodiments of the present disclosure;

FIG. 26 is a simplified, exemplary flow diagram depicting a process for training the voice analyzer module, in accordance with one or more embodiments of the present disclosure; and

FIG. 27 is a simplified, exemplary flow diagram depicting a process for utilizing the voice analyzer module to identify voice characteristics of voice segments, in accordance with one or more embodiments of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

As used in this disclosure, the terms “component,” “unit” and “system” are intended to refer to a computer-related entity, either hardware, a combination of hardware and software, software, or software in execution. For example, a component can be, but is not limited to being, a process running on a processor, a processor, an object, an executable, a thread of execution, a program, an algorithm and/or a computer. By way of illustration, both an application running on a server and the server can be a component. A component can be localized on one computer and/or distributed between two or more computers. Likewise, as used in this disclosure, the term “database” is intended to refer to one or more computer-related entities for the storage and access of data; and does not necessarily pertain to any manner or structure in which such data is stored. Further, the recitation of a first database and a second database does not necessarily require that such databases are separate from one another, either with respect to the data storage location(s), device(s) and/or structure(s).

Implementations of illustrative embodiments disclosed herein may be captured in programmed code stored on machine readable storage mediums, such as, but not limited to, computer disks, CDs, DVDs, hard disk drives, programmable memories, flash memories and other permanent or temporary memory sources. Execution of the programmed code may cause an executing processor to perform one or more of the methods described herein in an exemplary manner.

A network diagram of an exemplary digital advertising system 10 is illustrated in FIG. 1. In one embodiment, the advertising system 10 can be implemented as a networked client-server communications system. To this end, the system 10 may include one or more client devices 12, one or more application servers 14, and one or more database servers 16 connected to one or more databases 18. Each of these devices may communicate with each other via a connection to one or more communications channels 20. The communications channels 20 may be any suitable communications channels such as the Internet, cable, satellite, local area network, wide area networks, telephone networks, or the like. Any of the devices described herein may be directly connected to each other and/or connected over one or more networks 22. While the application server 14 and the database server 16 are illustrated as separate computing devices, an application server and a database server may be combined in a single server machine.

One application server 14 may provide one or more functions or services to a number of client devices 12. Accordingly, each application server 14 may be a high-end computing device having a large storage capacity, one or more fast microprocessors, and one or more high-speed network connections. One function or service provided by the application server 14 may be a web application, and the components of the application server may support the construction of dynamic web pages.

One database server 16 may provide database services to the application server 14, the number of client devices 12, or both. Information stored in the one or more databases 18 may be requested from the database server 16 through a “front end” running on a client device 12, such as a web application. On the back end, the database server 16 may handle tasks such as data analysis and storage.

Relative to a typical application server 14 or database server 16, each client device 12 may typically include less storage capacity, less processing power, and a slower network connection. For example, a client device 12 may be a personal computer, a portable computer, a personal digital assistant (PDA), mobile phone, a microprocessor-based entertainment appliance, a peer device or other common network node. The client device 12 may be configured to run a client program (e.g., a web browser, an instant messaging service, a text messaging service, or the like) that can access the one or more functions or services provided by the application server 14. Moreover, the client device 12 may access information or other content stored at the application server 14 or the database server 16.

The system 10 may provide an interactive digital advertising platform for use by various media sites or other advertisers. Accordingly, the application server 14, database server 16 and database 18 may be operated by an advertiser 24. According to one or more embodiments, the interactive digital advertising platform may act as a middleware solution that media sites can use as an advertising monetization tool. In the context of the disclosed advertising system, the client devices 12 may be representative of various client entities that interact with the advertiser 24 through a client device 12. As shown in FIG. 1, the clients may at least include lead requestors 26 and responders 28. Additionally, the clients may further include third-party validators 30 in accordance with one or more embodiments of the present disclosure, as will be described in greater detail below.

The present disclosure relates generally to a digital advertising platform for generating qualified leads using dynamic, interactive advertising units. As will be described in greater detail below, the interactive advertising units may be adaptive based on a combination of “observed” information and “declared” information. Observed information may include browsing habits and search patterns of users, pre-screening speed, social media behavior, speed at which the individual answers a pre-qualification questionnaire (e.g., a job application), and voice pattern, inflection, pitch and tone, or the like. Declared information, on the other hand, may include responses to specific questions served by advertising units. Accordingly, the system 10 embodies an interconnected digital advertising ecosystem in which lead requestors may be linked together through self-learning technology capable of aggregating performance data of advertising units across multiple sources and leveraging the information learned therefrom to improve current and future advertising units in real time.

For exemplary purposes, various aspects of the present disclosure will be described herein with specific reference to a system for generating interactive advertising units for use in recruiting potential employees, particularly hourly-wage workers, on behalf of employers. However, it is not intended that these aspects be limited to an hourly jobs recruiting platform. Rather, the disclosed embodiments are merely exemplary of an invention that may be embodied in various and alternative forms. Specific structural and functional details disclosed herein merely form a representative basis for teaching one skilled in the art to variously employ the subject matter described in the present disclosure. Therefore, the digital advertising platform described in the present disclosure may be equally applicable to other vertical or horizontal advertising units for generating qualified leads, such as may be used in car sales, insurance sales, online dating services, and credit card approvals, to name just a few.

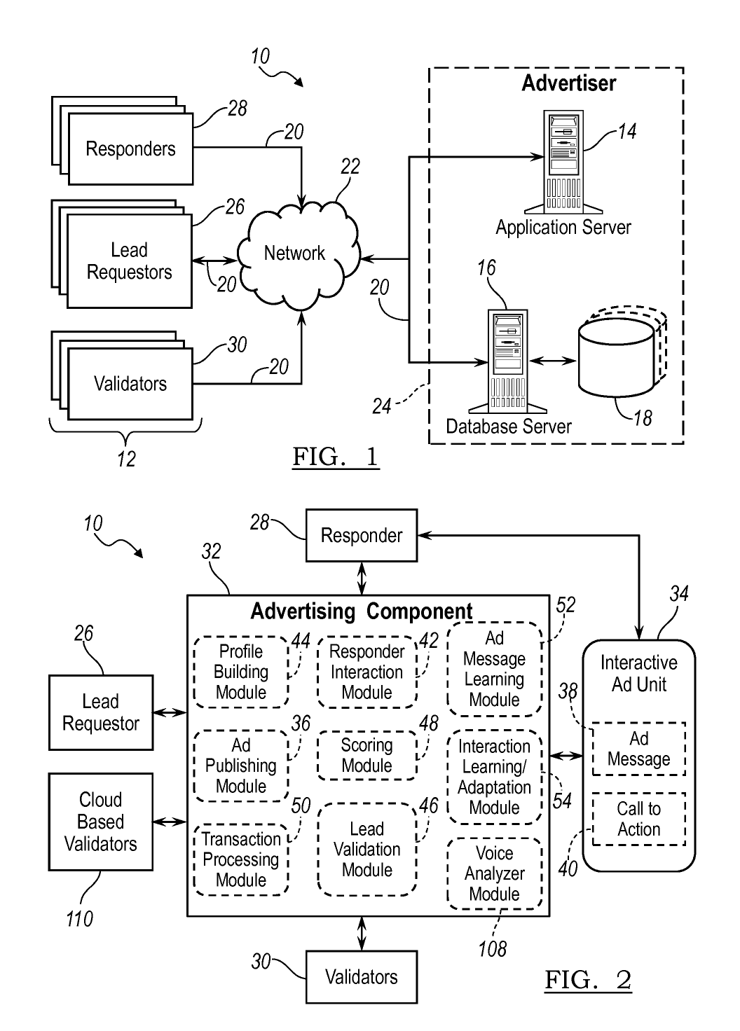

FIG. 2 illustrates a high-level block diagram of the exemplary digital advertising system 10. Central to the system 10 is an advertising component 32, which provides the platform for generating qualified leads. The advertising component 32 may include a number of sub-components or modules for performing the various functions provided by the digital advertising platform. Similar to a component, a module may refer to a process running on a processor, a processor, an object, an executable, a thread of execution, a program, an algorithm and/or a computer. Thus, each module may not necessarily refer to a discrete piece of hardware, software, or some combination thereof. Rather, the exemplary modules described in the present disclosure are merely intended to identify various functions of the advertising component 32 in structural terms.

A lead requestor 26 may interact with the advertising component 32 online. A lead requestor may be an individual or entity seeking qualified leads via the advertising component 32. In particular, the lead requestor 26 may submit a request for leads to the advertising component 32 via an online, fillable web form accessed through a website hosted by the advertiser 24. Leads may be requested in this manner using any type of client device 12, which may include mobile devices such as smart phones or tablets in addition to personal computers and the like.

The advertising component 32 may be integrated as part of a dedicated digital advertising source having its own interactive website. Lead requestors may connect to the advertising component 32 directly by logging on to the dedicated site hosted by the digital advertiser. Alternatively, the advertising component 32 may be a middleware solution for various media sites, as previously mentioned. To this end, a lead requestor 26 may log on to a third-party media site to submit a lead request. The third-party site may then send the lead request to the advertising component 32 using, for example, an extensible markup language (XML) file. The third-party site may also send a lead requestor 26 to a co-branded site hosted by the digital advertising source operating the advertising component 32. In this manner, it may appear to lead requestors 26 that they are on the third-party site even though they may actually be on the source site for the advertising component 32.

In the context of an hourly jobs recruiting platform, the advertising component 32 may be a middleware solution for a number of job boards. Further, a lead requestor 26 may be an employer seeking to hire an hourly-wage employee (e.g., a barista in a coffee shop, a cook in a diner, etc.). The employer may log on to a third-party website, such as a job board site, and post a job using the third-party's site, which sends the job posting to the advertising component 32. Alternatively, the employer may log on to the source website hosted by the job recruitment platform provider. Whichever the method, the employer may post a job opening through the advertising component 32 by submitting a description and various details relating to the position and its requirements.

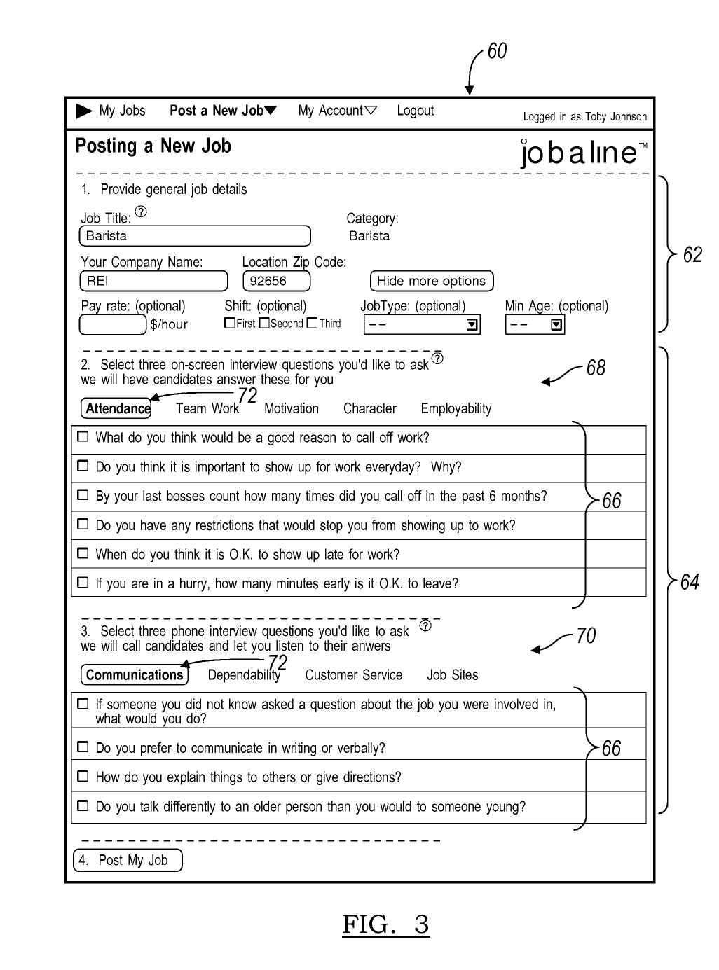

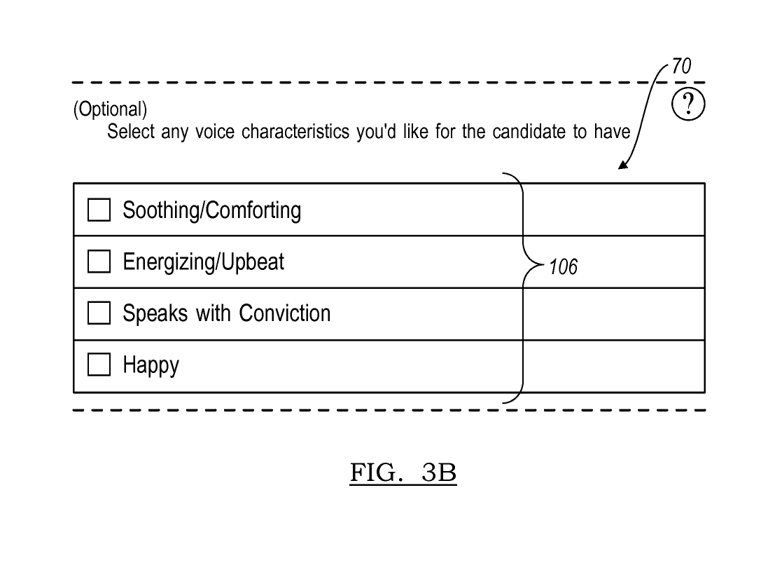

FIG. 3 illustrates an exemplary web form 60 for submitting a lead request, in accordance with one or more embodiments of the present disclosure. In the particular example shown, the web form 60 may provide a way for an employer to request leads for a job opening. An employer may log on to a particular job recruiting website and select an option to post a new job. Although the example depicted in FIG. 3 pertains to a job recruiting platform, it is intended to be generally illustrative of the manner in which leads may be requested for any advertising platform. Thus, the advertising component 32 may receive particular advertising requests via lead request web forms filled out and electronically submitted by lead requestors 26. In response to a lead request, an interactive advertising unit 34 may be generated and published by the advertising component 32.

The lead request web form 60 may include a general details section 62. A lead requestor 26 may define the basic advertisement parameters for a lead request in the general details section 62. For instance, the exemplary job posting web form, the general details section 62 may include blanks or other widgets for employers to input information about the job opening such as a job title, company name and job location. The advertising component 32 may require certain basic information about a particular lead request before it can be submitted by a lead requestor 26. Further, the general details section 62 may include space for receiving optional information as well from a lead requestor 26. For example, an employer may include additional details such as pay rate, job shift, job type, minimum age, etc.

The lead request web form 60 may also include a one or more user selectable inquiry sections 64. Each user selectable inquiry section 64 may provide space for lead requestors to select a number of pre-screening inquiries 66 to be made on their behalf by the interactive advertising unit 34. The pre-screening inquiries 66 may be selected, for example, by checking an adjacent box or selecting an adjacent button. The pre-screening inquiries 66 may include questions, criteria, conditions, or other information prompts for potential responders 28. For example, the pre-screening inquiries 66 may include pre-written interview questions to be asked of job applicant responders by interactive advertising unit 34. As another example, the pre-screening inquiries 66 may include selectable paralinguistic voice characteristics 106 (sometimes referred to herein as voice characteristics 106) that may be desired for job applicants. An example of selectable paralinguistic voice characteristics 106 is illustrated in FIG. 3B. Moreover, a number of the pre-screening inquiries available for selection may vary based on the specifics of the lead request. For instance, at least some of the selectable interview questions may be the same for any job type or description, while others may depend on the particular job position to be posted. Interview questions and/or voice characteristics 106 relevant to an employer seeking a barista, for example, may not be relevant to an employer seeking a janitor.

According to one or more embodiments of the present disclosure, the user selectable inquiry sections 64 may include an on-screen inquiry section 68 and a telephone inquiry section 70. In the on-screen inquiry section 68, a lead requestor 26 may select a number of inquiries 66 to be asked by an interactive advertising unit 34 soliciting written responses or other manual feedback from responders 28. On the other hand, in the telephone inquiry section 70, a lead requestor 26 may select number of inquiries 66 for soliciting an audible response during a telephone interview session. As will be explained in greater detail below, an interactive advertising unit 34 may call a responder 28 to solicit the audible responses to inquiries selected by the lead requestor 26 in the telephone inquiry section 70.

The pre-screening inquiries 66 may be grouped into a number of different categories 72. As shown in FIG. 3, selectable interview questions may be grouped into such exemplary topics as attendance, teamwork, motivation, character, employability, communications, dependability, customer service, or job skills. In order to streamline the pre-screening process, the quantity of pre-screening inquiries 66 that may be chosen by a lead requestor 26 may be limited in number. In this manner, a lead requestor 26 may select inquiries 66 believed to be the most relevant in uncovering qualified leads. In one or more embodiments, lead requestors 26 may input their own pre-screening inquiries 66. Moreover, such crowd-sourced pre-screening inquiries may be added to a library of user selectable pre-written inquiries 66 for future use.

The pre-screening inquiries 66 may further include a grouping of voice characteristics 106 that may be desired for the qualified leads. As shown, the voice characteristics 106 selection is included as a portion of the telephone inquiry section 70, but it should be noted that in other examples, the voice characteristics 106 may be included in another section or in a separate section of the pre-screening inquiries 66. Paralinguistic voice characteristics 106 may refer to aspects of spoken communication that do not involve words. Paralinguistic voice characteristics 106 may, for example, add emphasis or shades of meaning to the words and content of what a speaker of the voice segment may be saying. In the example shown in FIG. 3B, the voice characteristics 106 may include that a voice is soothing/comforting, energizing/upbeat, speaks with conviction, or sounds happy. As some other examples, the voice characteristics 106 may include that a voice is high or low pitched, or that the voice takes short or long pauses. In some cases, the voice characteristics 106 may be prepopulated according to the other criteria, such as by way of default voice characteristic template associated with particular job types. In an example, for a financial services job type, the voice characteristics 106 may pre-populate with criteria such as a voice that does not hesitate, or a voice that is energized. The voice characteristics 106 may also be customizable by the lead requestor 26. In an example, a dating profile lead requestor 26 may select to date people with low voice or who talk with long pauses.

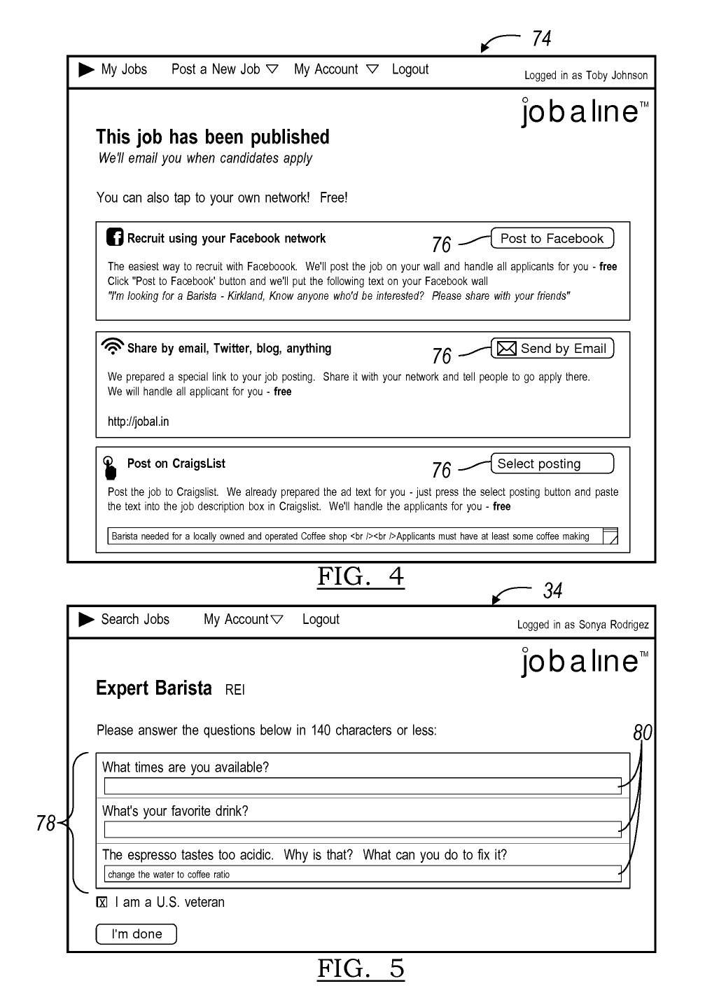

Once the lead requestor 26 has completed the general details section 62 and each user selectable inquiry section 64, the advertising request may be submitted online where it can be received by the advertising component 32. FIG. 4 depicts an exemplary online screen 74 that may be displayed once the advertising request has been submitted. Here, the advertising component 32 may inform lead requestors 26 how and/or when they will be notified of potential leads. In general, the advertising component 32 may publish digital advertising units 34 online in various media sites that form a part of the interconnected digital advertising ecosystem. Further, as illustrated in FIG. 4, the advertising component 32 may also tap into the lead requestor's network, with proper authorization, on its behalf. To this end, the advertising component 32 may automatically generate messages pertaining to the lead request for email distribution or publication to one or more social media networks (e.g., Facebook, LinkedIn Twitter, blogs, etc.) of the lead requestor. Additionally or alternatively, the advertising component 32 may provide lead requestors 26 with an option to post their advertisement on a classified advertisements website, such as Craigslist. Moreover, these automatically generated messages may include instructions and/or a hyperlink for responders 28. Accordingly, the online screen 74 may include one or more widgets 76 that a lead requestor 26 may engage to tap into these additional networks in a known manner.

Referring back to FIGS. 1 and 2, the advertising component 32 may be configured to receive a lead request having at least a general description and a number of user selectable pre-screening inquiries 66. Moreover, the pre-screening inquiries 66 may solicit text and or voice responses from potential leads. In response to the lead request, an interactive advertising unit 34 may be generated and published by the advertising component 32, as previously mentioned. Accordingly, the advertising component 32 may include an advertisement publishing module 36 for composing interactive advertising units 34 based on input received from lead requestors 26.

At its most basic level, an interactive advertising unit 34 may be constructed from a number of data elements representative of data, stored in the databases 18, that is organized and conveyed to a user in an understandable manner. According to one or more embodiments, an interactive advertising unit 34 may be embodied as an interactive web page, an inline frame or object elements within a web page, or the like. Each interactive advertising unit 34 may include an advertising message 38 and a call-to-action message 40. The advertising message 38 may convey the nature of the request to the public, while the call-to-action message 40 may lead interested recipients of the advertising message to start an interactive experience with the advertising unit 34. Responsive recipients of the advertising message 38 are referred to generically throughout the present disclosure as responders 28. For instance, the advertising message 38 in the exemplary hourly jobs recruiting platform may contain a description of a job opening posted by an employer. Therefore, the responders 28 may be job applicants in this context. However, responders 28 could include credit card applicants, car buyers, or the like, depending on the particular implementation of the advertising system and method described in the present disclosure.

The call-to-action message 40 may include instructions for responding to the advertising message 38 and may provide one or more means of contact offered by the interactive advertising unit 34, such as a phone number, a universal resource locator (URL), text messaging (e.g., short message service (SMS)), instant messaging (IM), and the like). The call-to-action message 40 may further include call-to-action buttons or widgets (not shown) that may automatically take action on the responder's behalf upon activation. As used herein, the term “widget” generally refers to a software-based component of any graphical user interface in which a user interacts, whether it be on a computer, a website, a mobile device, a hand-held device, and the like. For example, a widget may be a graphical user interface element that may provide a single interaction point for manipulating a given kind of data. In one example, a widget may include a web widget, which may include any code that may be embedded within a page of hypertext markup language (HTML), e.g., a web page.

The advertising unit 34 may be interactive such that responders 28 may engage with the advertising component 32 via the interactive advertising unit. In this regard, the advertising unit 34 may do more than send a message to a crowd as static text. It may also invite users to start an interactive experience. For instance, the advertising unit 34 may solicit responses and other feedback from responders 28 based at least in part on the pre-screening inquiries 66 selected by the lead requestor 26. Accordingly, the interactive advertising unit 34 may essentially prompt responders 28 to qualify themselves as potential leads, which can then be offered to a lead requestor 26 for purchase. For this purpose, the advertising component 32 may further include a responder interaction module 42 that coordinates and facilitates these interactions with a responder 28. The interactive advertising unit 34 may essentially interview a responder 28 by asking the responder questions or requesting the responder to provide relevant information based on the lead requestor-selected pre-screening inquiries 66. The interactive advertising unit 34 may prompt text-based and/or voice-based responses 130 (discussed in further detail below).

FIG. 5 depicts an exemplary interactive advertising unit 34 for a job board posting running on a website. The interactive advertising unit 34 may conduct an online interview with a job applicant responder. Accordingly, the advertising unit 34 may ask a job applicant responder a number of preselected interview questions. As described in the preceding paragraphs, the interview questions may be selected by the employer from group of possible interview questions when the job posting is created. Additionally or alternatively, employers may submit their own interview questions. The interactive advertising unit 34 may prompt text-based responses to select questions. As shown in FIG. 5, the applicant may type responses to a first series of interview questions 78 in text fields 80 adjacent to each question. In a web interview, the interactive advertising unit 34 may interact with responders 28 by laying out the questions and/or other dynamic elements on a web page, enabling responders 28 to complete the text-based portion of the interview in essentially a single transaction. Although the questions could be laid out over several web pages, the interactive advertising unit 34 running on a website may allow a responder 28 to address more than one question at a time. Accordingly, responses to all questions may be processed in a batch.

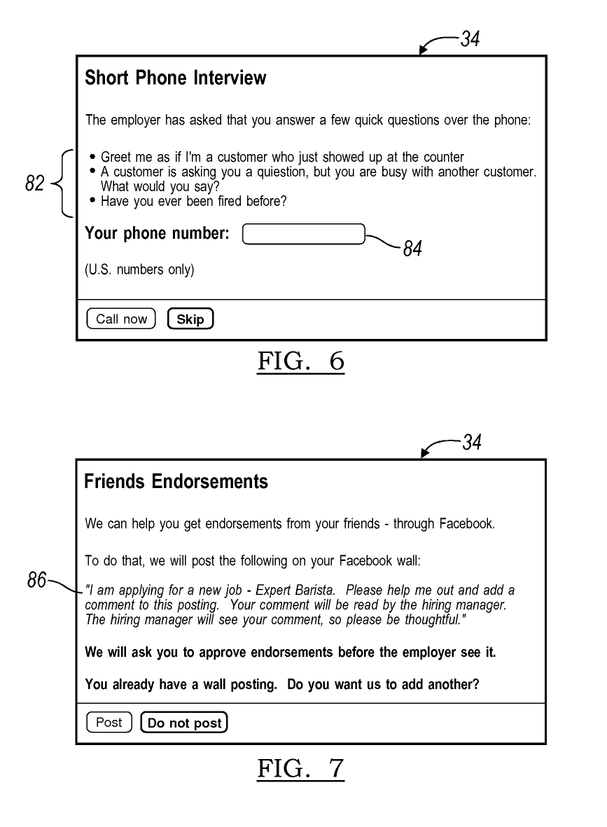

The advertising unit 34 may also be voice-powered. As shown in FIG. 6, the advertising unit 34 may also call the applicant to conduct an automated phone interview in which a number of additional interview questions may be asked, in accordance with one or more embodiments of the present disclosure. As with the text-based questions 78, the phone interview questions 82 may also be selected by the employer ahead of time. The advertising unit 34 may instruct the job applicant responder to enter a telephone number where the applicant can be reached into a numerical field 84. Once the telephone number is submitted, the advertising unit 34 may call the applicant to continue the interview process. The voiced-based responses to the phone interview questions may be recorded and analyzed by the advertising component 32 along with the text-based responses. In an example, the voice-based responses are 130 translated from speech to text, and are further analyzed for voice characteristics 106 that may be desired for qualified leads. In one or more embodiments, a responder 28 may optionally skip the phone interview portion of the pre-screening process.

If the interactive advertising unit 34 is running on a media website, a responder 28 may interact with the advertising unit without leaving the site. Of course, interactions with the advertising unit 34 may occur outside of a web browser context, as mentioned above. The advertising unit 34 may provide real-time computerized interactions with responders 28 over any number of alternative communication mediums, including telephone, SMS, IM services, and the like. Interactive advertising units 34 built to run on the mobile web can open the target advertising space up to a larger segment of the population for media companies, not just those with smart phones or access to Internet browsers. Individuals with feature phones lacking a browser or data plan can now engage with interactive advertising units 34 over SMS, for example.

The same web interview described above in connection with FIG. 5 may also be conducted over devices and/or protocols that are real-time in nature, such as phone SMS or IM chat. Conducting a real-time computerized interview with a responder 28 over SMS or IM can introduce unique challenges in comparison to an interactive web interview. Since there is no URL, in order to initiate the correct interview or other inquiry, the advertising component 32 may assign a unique identification code to each lead request (e.g., job posting). The unique identification code may then be used by responders 28, such as job applicants, to initiate an interview. According to one or more embodiments, a unique identification code may be reused or recycled. However, in order to avoid any overlap in lead requests, the advertising component 32 may wait a predetermined period of time after a lead request is closed and no longer available before the same code can be assigned to another lead request. These unique identification codes may also be published in offline advertisements, such as newspaper classified advertisements, which can have a longer shelf life than an online page. Therefore, the predetermined wait period before a unique identification code can be recycled may account for the longer shelf life of offline publications.

The unique identification codes may be produced in a non-serialized manner in order to reduce the likelihood of initiating the wrong interview due to a typing mistake by a responder 28. To this end, the advertising component 32 may employ a random number generator to select a random number between a range of numbers to assign as the unique identification code. The advertising component 32 may then check if there is an active identification code associated with another lead request within a predefined threshold around the number selected by the random number generator to minimize potential collisions between nearby numbers.

The advertising unit 34 may construct a SMS interview with a responder 28 using the same database 18 used to construct web interviews. The workflow may be consistent with that of a typical “live person” interview with real-time questions and responses. The advertising unit may present each question to a responder 28 in a SMS message or IM chat and wait for an answer in a reply message before presenting a subsequent question. Moreover, the interactive advertising unit 34 may account for the maximum permissible message length for the protocol employed and may break the message into parts accordingly. For example, messages longer than 160 bytes may be broken into two or more parts when using a SMS protocol. Based on each particular question, the advertising component may expect a certain range of allowed responses. If a received response is not within the expected range of acceptable responses, the advertising unit 34 may send a message to that effect to the responder 28.

The state of the interview may be kept in a database, such as database 18. This may be necessary to maintain the proper sequence of interactions with a responder 28 and match received responses with the corresponding questions. Accordingly, if the responder 28 takes a relatively long break between answering questions, the advertising unit 34 can recall to which question an eventual response correlates. Tracking and saving the state of an interview may also help if the interview is interrupted or otherwise fails to be completed. If the responder 28 attempts to initiate the same interview again using the unique identification code, the responder may be identified by the responder's caller identifier (ID) attached to the SMS message or IM chat. The advertising unit 34 may recall the interview based on the unique identification code and caller ID and resume the interview where it last stopped.

According to one or more embodiments, the interactive advertising unit 34 may be multi-lingual. During interactions, the advertising unit 34 may transmit questions in a responder's native language. The advertising component 32 may also translate responses to a lead requestor's native language. The advertising component 32 may also be configured to transcribe verbal responses to text in various supported languages, which may then be translated to the lead requestor's native language for evaluation.

By interacting with the advertising unit 34 using any of the above-described devices or protocols, responders 28 to an advertising message 38 are essentially asked to qualify themselves as a potential lead. The advertising component 32 may essentially pre-screen responders 28 on behalf of the lead requestor 26 and may identify the top leads from the pool of responders 28 to present to the lead requestor 26 for purchase. In this manner, the advertising component 32 may evaluate and score each responder 28 based on the responder's responses, analysis of the applicant's paralinguistic voice characteristics 106, and other associated interactions with the advertising unit 34. Moreover, the advertising component 32 may build a profile for each responder 28. To this end, the advertising component 32 may further include a profile building module 44. The profile may include information relating to the interactions between the advertising unit 34 and the responder 28, including text-based and/or voice-based responses 130 to the pre-screening inquiries 66. By asking the responder 28 various questions or seeking other relevant information from the responder 28, the advertising unit 34 may help build a responder profile. For instance, the profile for a job applicant responder may essentially become the applicant's virtual resume and include the applicant's responses to the various interview questions, including recorded audio of each voice-based response 130 and an analysis of the applicant's paralinguistic voice characteristics 106. Accordingly, profiles may reflect responders' overall activity as a way of showing who they are to a lead requestor (e.g., an employer) that may want to purchase a lead based on a profile.

According to one or more embodiments of the present disclosure, the advertising component 32 may attempt to validate a responder 28 by collecting feedback from one or more third-party sources, referred to as validators 30. Accordingly, the advertising component 32 may further include a lead validation module 46 for engaging third party validators 30 and processing feedback receive therefrom. Validators 30 may include individuals acquainted with a responder 28 or other entities having a connection to the responder 28, which can provide references that further qualify the responder as a potential lead. For example, the advertising component 32 may request endorsements from validators 30 to include in the responder's profile. In certain implementations, responders 28 may be given the option of seeking endorsements to bolster the responder's profile. If a responder 28 desires to obtain endorsements, the advertising component 32 may facilitate the endorsement process by engaging a responder's acquaintances.

The advertising component 32 may solicit endorsements from the acquaintances on behalf of a responder 28 in a relatively frictionless manner to encourage feedback. The advertising component 32 may interact with endorsers or validators in a number of ways, including social media, instant messaging, SMS text messaging, or through other cellular phone services. For example, the advertising component 32 may request endorsements from a responder's contacts using a social media platform. Upon receiving authorization, the advertising component 32 may post a message on a responder's behalf seeking endorsements from the responder's social media contacts. The advertising component 32 may repurpose the comments section for collecting endorsements. Thus, the social media contacts may endorse the responder 28 by commenting on a corresponding post. In a similar way, the advertising component 32 may also collect endorsements by repurposing IM chats, SMS text messages, or the like, exchanged with third-party validators 30.

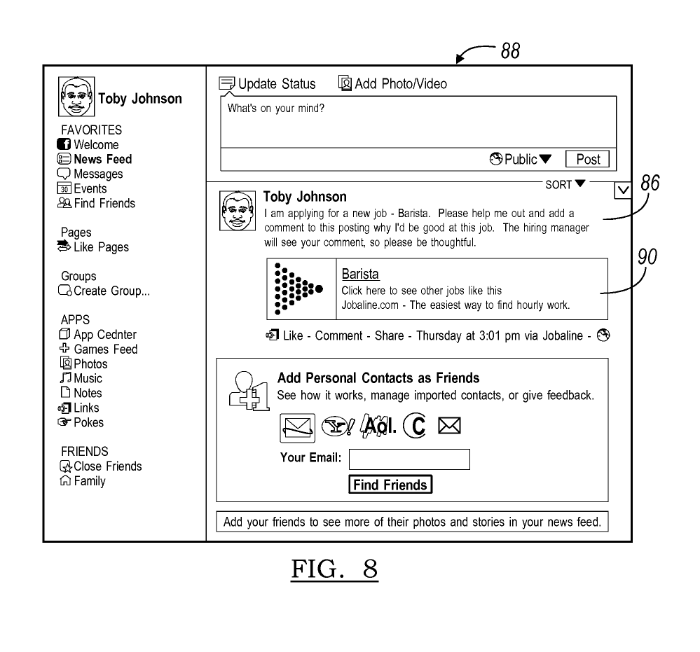

FIGS. 7 and 8 illustrate an example of how endorsements may be sought in the hourly job recruiting context using social media. As shown in FIG. 7, the advertising unit 34 may request authorization to post a message 86 through a social networking platform. With authorization from the job applicant responder, the advertising component 32 may post the message 86 on a social networking site 88 on the job applicant responder's behalf informing the applicant's friends or other social media contacts about the job the applicant is seeking, as shown in FIG. 8. The message 86 may include a request for endorsements that may aid in the evaluation of the applicant. The social media post may also include a link 90 to the actual job posting published by the advertising component 32 connecting a media site or online job board to the social media platform's distribution. Social media contacts may endorse the job applicant responder by commenting on the corresponding post. As previously described, the advertising component 32 may repurpose the comments section to collect endorsements from the job applicant's social media contacts. Endorsements may also include references from previous employers. Accordingly, the advertising component 32 may be configured to prompt one or more former employers of a job applicant responder to provide a reference.

In addition to obtaining personal endorsements, the advertising component 32 may collect additional information or references to further qualify a potential lead, such as bank references, medical references, skill references, or the like. Moreover, the third party references may not be limited to feedback from humans. According to one or more embodiments of the present disclosure, the advertising component 32 may collect endorsements, references, or other information to further qualify a lead by automatically querying a third party database. One such example may include obtaining a credit score for a potential lead applying for a credit card or bank loan. In certain instances, such as in the preceding example, the lead may have to provide authorization and/or personally identifiable information (e.g., social security number) to the advertising unit 34 before a third party database can be queried. The advertising unit 34 may prompt a responder 28 to provide at least a minimum level of personal information in order to verify that the responder is legitimate. The advertising component 32 may check the personal information against legal databases, such as those used by the Federal Bureau of Investigation (FBI) or Department of Motor Vehicles (DMV), to confirm a responder's identity and guard against spammers and bots. Overall lead quality may be improved by using a validator 30 to confirm that human responders are real people with legitimate backgrounds.

Validators 30 may also validate or authenticate other information previously submitted to the advertising unit 34 by a responder 28. To this end, the advertising component 32 may probe validators 30 to confirm or verify such information. For instance, the advertising component 32 may verify certain skills or credentials submitted by a responder 28 by probing an accreditation source or similar entity.

The responder 28 may be provided the opportunity to accept or reject each endorsement or reference. The option to accept or reject third party feedback may also depend on the particular implementation of the advertising system described in the present disclosure. For instance, while the option to accept or reject endorsements may be sensible in a job recruitment advertising platform, it may not be for other vertical advertising units.

Accepted endorsements may be incorporated into a responder's profile for potential review by a lead requestor 26. The endorsements may also be factored into the scoring algorithm used to evaluate the responder, as will be discussed below. To this end, the endorsements may be scrutinized and weighted by the advertising component 32. As an example, endorsements that are not relevant to the lead request may be filtered out. Moreover, an endorsement from a validator 30 that has been deemed credible may be weighted more heavily than an endorsement from a less credible endorser. The advertising component 32 may assess the credibility of validators 30 based on previous endorsements, such as whether a validator's endorsements are generally accepted by a responder 28. The credibility of validators 30 may also be based on the content of their endorsement, their relationship with the responder, the overall number of endorsements they give out, the nature and quantity of their friends or contacts, and the like.

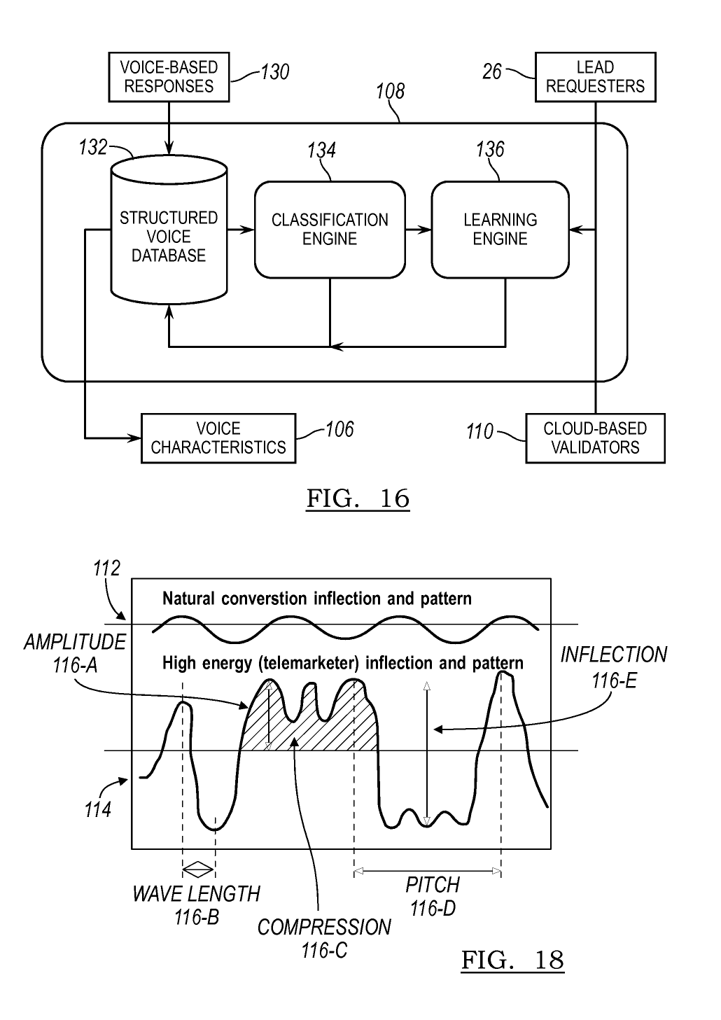

According to one or more embodiments of the present disclosure, the advertising component 32 may attempt to classify the paralinguistic voice characteristics 106 of a responder 28 by performing a voice analysis on the voice responses provided by the responder 28 in answering the phone interview questions 82. Accordingly, the advertising component 32 may further include or otherwise utilize a voice analyzer module 108 for categorizing aspects of the paralinguistic voice characteristics 106 of the responder 28 providing voice samples according to a voice database. In an example, the voice analyzer module 108 may train the data of the voice database using input received from cloud-based validators 110 configured to perform cloud-based learning of paralinguistic voice characteristics 106. Based on the trained voice database, the voice analyzer module 108 may be able to identify paralinguistic voice characteristics 106 of the responder 28 according to how the phone interview questions 82 are answered, independent of the content of the words of the voice answers to the phone interview questions 82. Further aspects of the voice analyzer module 108 are discussed in detail below with respect to FIGS. 16-27.

A complex scoring algorithm may be employed by the advertising component 32 in the evaluation of each responder 28. The advertising component 32 may further include a responder scoring module 48 for this purpose. The scoring module 48 may evaluate a responder 28 based on the responder's responses to various inquiries or questions prompted by the interactive advertising unit 34. Additional criteria may be applied to the scoring algorithm in the evaluation of each responder 28, such as voice characteristics 106, geographic proximity, endorsements or other validations, interests, responsiveness to the advertising unit 34, time spent engaging with the advertising unit 34, etc. The advertising component 32 may then rank the various responders 28 based on their scores and select a subset of candidates therefrom to present to the lead requestor 26 as potential leads or matches. Rather than identify the best candidate for a lead requestor 26, the advertising component 32 may help the lead requestor 26 identify several top candidates or matches to focus on and possibly purchase.

In the hourly job recruiting example, the interactive advertising unit 34 ultimately digitizes the initial interview process by automatically pre-screening responders 28 and filtering out the best candidates for an employer to review. Thus, employers may avoid having to interview a relatively large number of applicants themselves, thereby streamlining the hiring process. By employing the interactive advertising units 34 of the present disclosure, other types of advertising platforms outside of the job recruitment context may also enjoy the advantages of streamlined lead generation provided by the advertising system 10.

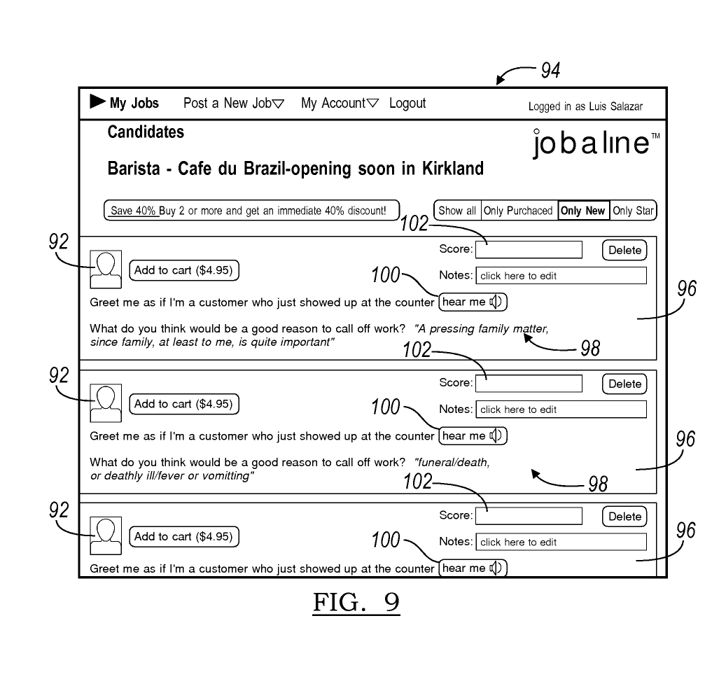

With reference to FIG. 9, leads 92 may be presented to the lead requestor 26 online. For instance, the lead requestor 26 may access an online account through a web portal to view leads 92 responsive to each advertisement request in a browser 94. According to one or more embodiments of the present disclosure, the advertising component 32 may provide lead requestors 26 with only a preview of each lead's profile 96. As such, only portions of a lead's profile 96 may be disclosed to the lead requestor 26. The partial lead profile 96 may include a free preview of at least one text answer 98 to an inquiry, such as an interview question. Moreover, the partial lead profile may include a free preview of a responder's voice answer 100 to a question (e.g., to allow the lead requestor 26 to verify the desired voice characteristics 106 are present in the responder's voice answer 100). Alternatively, rather than a free preview of a text answer 98 or a voice answer 100, the advertising component 32 may offer a preview of answers at a discounted rate relative to the cost of purchasing the full profile. The profile 96 may also include a score 102 that the lead 92 was assessed by the advertising component's scoring module 48. The profiles 96 presented by the advertising component 32 may be anonymous; the names and contact information for each lead 92 may be withheld from the lead requestor 26. The lead requestor 26 may purchase the lead's full profile 96 and contact information from the advertising component 32. To facilitate the purchasing transactions, the advertising component 32 may also include a transaction processing module 50.

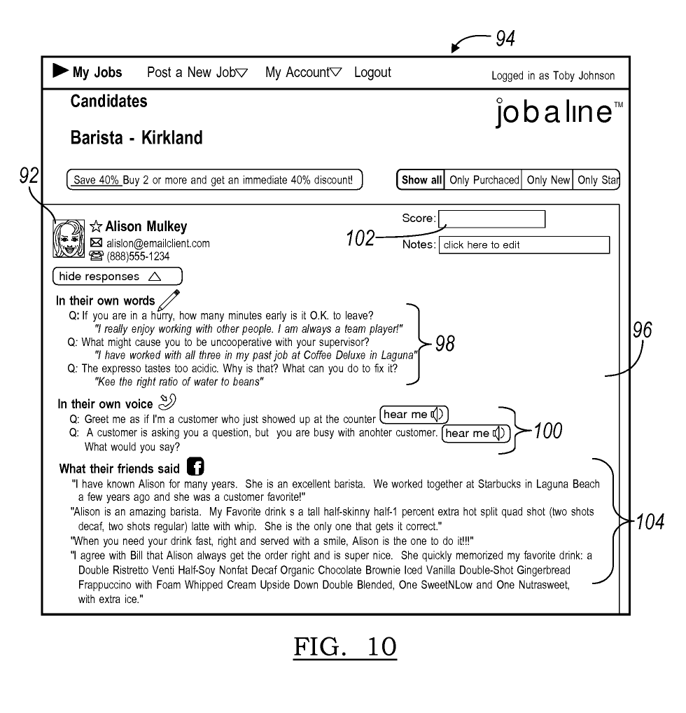

Once purchased, the advertising component 32 may provide the lead requestor 26 access to a lead's full profile 96, as shown in FIG. 10. In this manner, the lead requestor 26 can review all interactions between each lead 92 and the associated advertising unit 34. For instance, the lead profile 96 may contain responses to interview questions provided by a job applicant responder, including text answers 98 and voice answers 100. The lead profile 96 may also include endorsements 104 from third-party validators 30. Further, a responder's profile 96 may also include interactions between the responder 28 and other relevant advertising units 34.

According to one or more alternate embodiments, the advertising component 32 may provide the lead requestor 26 access to a lead's full profile 96 prior to purchase. The full profile presented by the advertising component 32 may still be anonymous prior to purchase. However, the lead requestor 26 may have full access to the profile help determine whether to purchase the lead's contact information. When a lead requestor 26 identifies a lead they are interested in, the lead's contact information can then be purchased from the advertising component 32 as set forth above.

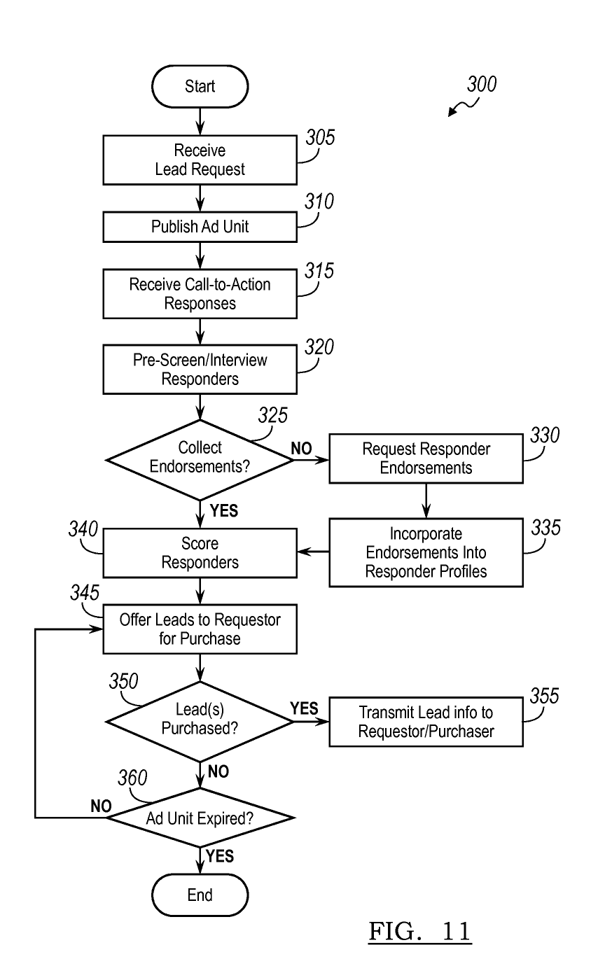

FIG. 11 is a simplified, exemplary flow chart depicting a method 300 for providing leads in accordance with one or more embodiments of the present disclosure. At step 305, the advertising component 32 may receive a request for leads from a lead requestor 26. The request may include a description of the advertisement as well as the selection of various pre-screening questions to ask potential responders 28. From the lead request, the advertising component 32 may generate and publish a digital interactive advertising unit 34, as provided at step 310. The advertising unit 34 may be published with a number of online sources, including on advertiser media sites, within search browsers, in electronic mail, and the like.

The advertising component 32 may prioritize the advertising units 34 it shows to users. For instance, a publication priority may be given to an advertising unit that has yielded relatively fewer leads compared to other advertising units. To help balance out the number of leads generated, the advertising component 32 may show advertising units with a lower number of leads first. The advertising component 32 may also factor in the number of leads already purchased by a lead requestor 26 when determining whether, or how frequently, to serve a corresponding advertising unit 34. If the quantity of leads already purchased tends to indicate that few, if any, additional leads will be purchased, the advertising component 32 may serve the advertising unit 34 less frequently, or stop altogether. The future purchasing behavior of a lead requestor 26 may be predicted by the advertising component 32 based on trends identified from past purchasing behavior. The past purchasing behavior may be specific to the lead requestor 26. For example, if historical purchase data associated with a particular lead requestor 26 is available, the advertising component 32 may evaluate the number of leads the lead requestor typically purchases per lead request. Based on this past purchase behavior, the advertising component 32 may predict the number of leads the lead requestor might purchase for a pending lead request. If the lead requestor has already purchased the typical allotment, the advertising component 32 may lower the publication priority of the corresponding advertising unit 34. Likewise, the advertising component 32 may identify other lead purchasing trends that are not necessarily specific to a particular lead requestor 26. Predictions may be based on purchase trends for all advertising units, advertising units sharing one or more similarities, or the like.

At step 315, the advertising component 32 may receive call-to-action responses from a number of responders 28 to the advertising unit 34. The advertising unit 34 may interact with each responder 28 in a number of ways based on the call-to-action, as previously described. For instance, the advertising unit 34 may interact with a responder 28 online, such as through a web page or instant messaging client. Additionally or alternatively, the advertising unit 34 may interact with a responder 28 over the phone or SMS.

At step 320, the advertising unit 34 may interact with a responder 28 and solicit relevant information for use in pre-screening the responder. For instance, the advertising unit 34 may ask the responder 28 a number of questions prompting the responder to self-qualify as a potential lead to present to the lead requestor 26. The advertising unit 34 may further inquire whether the responder 28 would like to collect third-party endorsements to help bolster the responder's candidacy as a potential lead, as provided at step 325. If the responder 28 wishes to seek endorsements from acquaintances, the advertising component 32 may publish a request for endorsements to the acquaintances on the responder's behalf, at step 330. For example, the advertising component 32 may post a message seeking endorsements on a responder's social media profile and repurpose comments to the post from the responder's social media contacts as endorsements. At step 335, the advertising component 32 may incorporate the endorsements into the responder's profile. The responder 28 may be allowed to accept or reject each third-party endorsement.

At step 340, each responder may be evaluated and scored based on responses given to the advertising unit 34. Moreover, if endorsements were collected, the endorsements may be factored into the scoring algorithm. Yet further, if voice characteristics 106 were specified for the advertisement, the voice characteristics 106 of the voice answers 100 may be factored into the scoring algorithm according to the voice identification performed by the voice analyzer module 108. Based on the scores, a number of the top leads or matches may be identified. At step 345, the leads may be presented to the lead requestor 26 for possible purchase. The presentation of leads may include a preview only of each lead's profile or may include full access to each lead's entire profile. If a lead looks promising, the lead requestor 26 may be given the opportunity to purchase the lead's contact information for follow-up. Alternatively, a purchaser can bid on the lead's price. In this regard, several purchasers may, in effect, compete for the same lead. At step 350, the advertising component 32 may determine whether any leads have been purchased. If the purchase of one or more leads has been requested, the advertising component 32 may then transmit lead contact information to the lead requestor 26, at step 355.

At step 360, the advertising component 32 may then determine whether the advertising unit 34 has expired. An advertising unit 34 may expire for any number of reasons. One such reason may occur when the lead requestor 26 informs the advertising component 32 that additional leads are not required. For instance, an employer may indicate that a job position for which leads were requested has been filled. Thus, the need for additional leads may be negated. Other reasons to expire an advertising unit may be due to such things as the number of pending leads that have not been reviewed yet or the amount of revenue the advertising unit has generated. If the advertising component 32 is still active, the process may return to step 345 for the presentation of additional leads. If no leads are purchased at step 350, the method may proceed directly to step 360 for a determination as to whether the advertising unit 34 has expired.

If a lead request is ultimately filled, the advertising component 32 may receive feedback from the lead requestor 26 to that effect. Depending on the implementation, the advertising component 32 may then flag the lead so the lead is not offered to other lead requestors. For instance, the advertising component 32 may flag hired applicants so that they are not offered to other employers as potential leads where they can then be poached.

In addition to being interactive, the advertising unit 34 may also be dynamic. In particular, the advertising component 32 may include one or more learning modules that learn from the interactivity between various advertising units 34 and responders 28. Through self-learning, the advertising component 32 may identify optimal advertising messages 38 for a particular advertising unit 34. Moreover, the advertising component 32 may learn to adapt a particular advertising unit's interaction prompts (e.g., questions or information requests) based on results of other advertising units 34. Interactive advertising units 34 containing dynamic content may be constructed on the fly from data extracted from databases 18 based on user (e.g., lead requestor, responder, etc.) information and interactions, including responses to questions.

The advertising component 32 may be an aggregator of information and data learned from all different advertising units 34. Moreover, as a middleware solution, in which the advertising component 32 provides services for numerous advertisers 24, aggregated advertisement performance can be observed and leveraged from multiple sources. From the vast number of observed interactions and feedback, the advertising component 32 can identify trends and modify an interactive advertising unit 34 in real time.

To this end, the advertising component 32 may aggregate the feedback generated from multiple advertising units 34, including feedback received from other advertising sources, and apply various learning algorithms to optimize current and future advertising units. For instance, the advertising component 32 may include an advertising message learning module 52. The advertising message learning module 52 may be employed to modify the advertising message 38 or description contained in an interactive advertising unit 34 in real time based on the observed aggregated performance of other advertising units across multiple advertisers 24. Thus, the advertising message 38 or description may change in real time based on the performance of similar advertising units 34. For instance, if one advertising unit 34 has a relatively large hit rate or number of impressions, the advertising message 38 for similar advertising units may be modified to attract more responders 28. The advertising message 38 may be further modified based on the feedback from user engagement, including call-to-action results and crowdsourcing inputs. This adaptability may be replicated throughout the ecosystem of similar advertising units without intervention from lead requestors as advertising units self-learn to deliver the best possible performance. For example, a lead requestor 26 seeking credit cards applications may start with an advertising message “A,” a call-to-action “B,” and a set of questions “1,” “2,” and “3.” Based on the collective performance of similar advertising units, the advertising component 32 may learn that the optimal advertising message is still “A,” but that call-to-action “M” and questions “1,” “2,” and “4” provide better results.

Accordingly, multiple permutations of the same advertising unit 34 may be deployed based on user engagement and aggregated performance throughout the advertising ecosystem. Additionally, the various learning algorithms may account for lead results post-purchase, including the perceived long-term successes and failures of purchased leads. For example, the advertising component 32 may learn from purchased leads that do not result in a hire, as well as those that do.

Not only may the advertising messages 38 be dynamic, the interactions between an advertising unit 34 and responders 28 may also be modified in real-time based on feedback aggregated from other advertising units. Accordingly, the advertising component 32 may further include an interaction and adaptation learning module 54 for applying a learning algorithm to feedback from observed aggregated performance of advertising units 34 to improve an advertising unit's interactions with responders 28. For example, the selected interview questions used to pre-screen job applicants may be modified or substituted in real time so that an advertising unit 34 can solicit responses that tend to yield the best results. By the same token, a list of available interview questions from which an employer may select when requesting leads for a job opening may constantly be updated to reflect the interview questions deemed most effective in other advertising units 34. Additionally, lead requestors 26 may submit their own questions to be asked by an advertising unit 34. As feedback on the effectiveness of these questions is received, they may be further modified and/or added to the list of available questions from which other lead requestors may select.

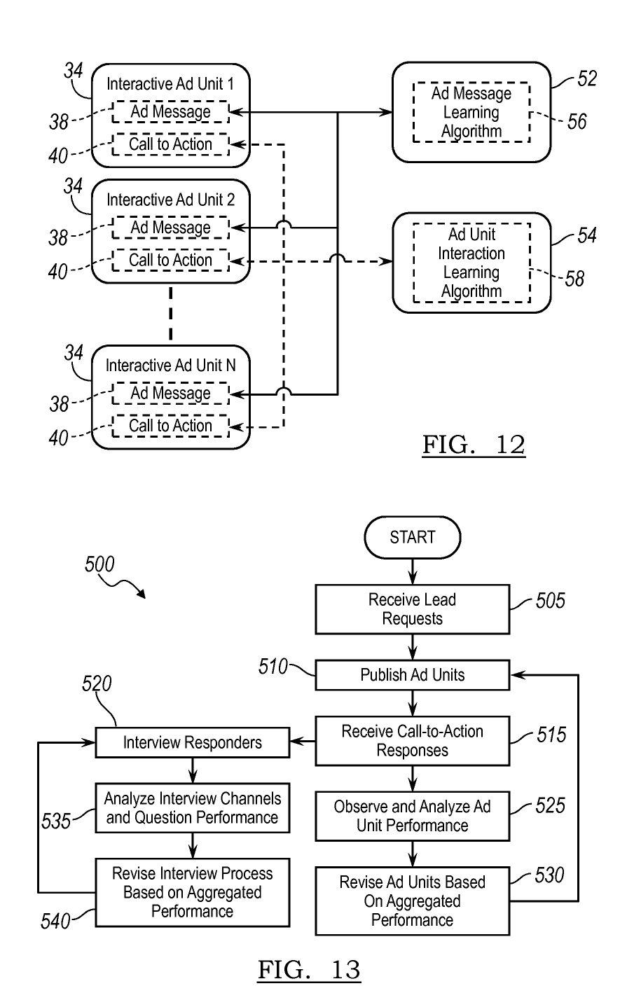

FIG. 12 is a simplified, exemplary block diagram illustrating the self-learning features of the advertising component 32 for generating dynamic advertising units 34. As seen therein, feedback relating to the performance of an advertising message 38 may be applied to an advertising message learning algorithm 56 forming at least a part of the advertising message learning module 52. Based on the learned performance of other advertising units 34, the advertising message 38 on a particular advertising unit 34 may be modified in real-time to optimize its effectiveness. Likewise, feedback relating to the effectiveness of call-to-action messages 40 and other interactions between advertising units 34 and responders 28 may be aggregated and applied to an advertising unit interaction learning algorithm 58 forming at least a part of the interaction learning and adaption module 54. The interaction learning algorithm 58 may help identify optimal interaction prompts for an advertising unit 34 to incorporate, including suitable questions to ask responders 28.

FIG. 13 is a simplified, exemplary flow chart depicting a method for dynamically modifying interactive advertising units 34 based on aggregated performance. Steps 505-520 may be similar to steps 305-320 as shown and described in connection with FIG. 11. Thus, the description of those steps will not be repeated here for purposes of brevity. At step 525, the performance of various advertising units 34 may be observed, aggregated and analyzed by the advertising component 32. The advertising component 32 may learn from the aggregated performance of advertising units 34 and may revise current advertising units accordingly, at step 530. For instance, the advertising component 32 may modify the advertising message 38 and/or call-to-action message 40 for a particular advertising unit 34 in real time based on learned performance of other advertising units that yielded a high number of responses. Once the advertising unit 34 has been modified at step 530, the process may return to step 510 wherein the revised advertising unit may be republished.

Similarly, at step 535, the advertising component 32 may analyze the aggregated performance of advertising units 34 based on interactions with responders 28. In particular, the advertising component 32 may identify the best communication channels to emphasize in future interactions. Additionally, the advertising component 32 may learn which questions or information requests tend to lead to the identification of successful leads. Accordingly, the advertising component 32 may modify or otherwise adapt advertising units 34 based on the trends and other information learned from the analysis of prior advertising units, as provided at step 540.

As previously described, the system and method for dynamically modifying an interactive advertising unit 34 may be replicated throughout the entire ecosystem of similar advertising units, including those requested from different sources, without lead requestor involvement as the advertising units self-learn to deliver optimum performance.

According to one or more embodiments of the present disclosure, the data obtained through interactions with responders 28 to various advertising units 34 may be further leveraged to “passively” advertise for lead requestors 26. Using passive advertising, the advertising component 32 may generate leads for a lead requestor 26 without responders even seeing a corresponding advertising unit 34. Rather, lead candidates may be selected from a pool of responders 28 to other advertising units whose profiles suggest a match to one or more requirements or other criteria of the lead request. Thus, responders 28 need not actively respond to a particular advertising unit 34 to be considered a viable candidate. This may be possible with data standardization. For instance, in the job recruiting platform, a barista is a barista. In effect, an applicant responder that applies for a job as a barista by responding to a particular advertising unit 34 publicizing that job opening can be considered a candidate for similar job postings without having to go through the interview process for each job posting. Thus, advertising component 32 may function as a virtual temporary worker agency. An employer in need of a replacement worker in an emergency would not necessarily even need to post a job. Rather, the employer can request the advertising component 32 to identify available leads that applied to similar jobs or that applied to the employer in the past.

Accordingly, the advertising component 32 can provide a lead requestor with leads selected from responders to similar lead requests. Additionally or alternatively, the advertising component 32 can provide a lead requestor with leads selected from responders with a profile match to one or more requirements, qualifications or other criteria of the lead request. The match between profile characteristics and lead request requirements may not necessarily be exact, particularly when considering answers to interview questions. Rather, the advertising component 32 may employ a proximity-based matching algorithm to identify quality leads that didn't directly respond to the subject advertising unit 34. The proximity-based matching may consider several lead requirements beyond just geographical matches.

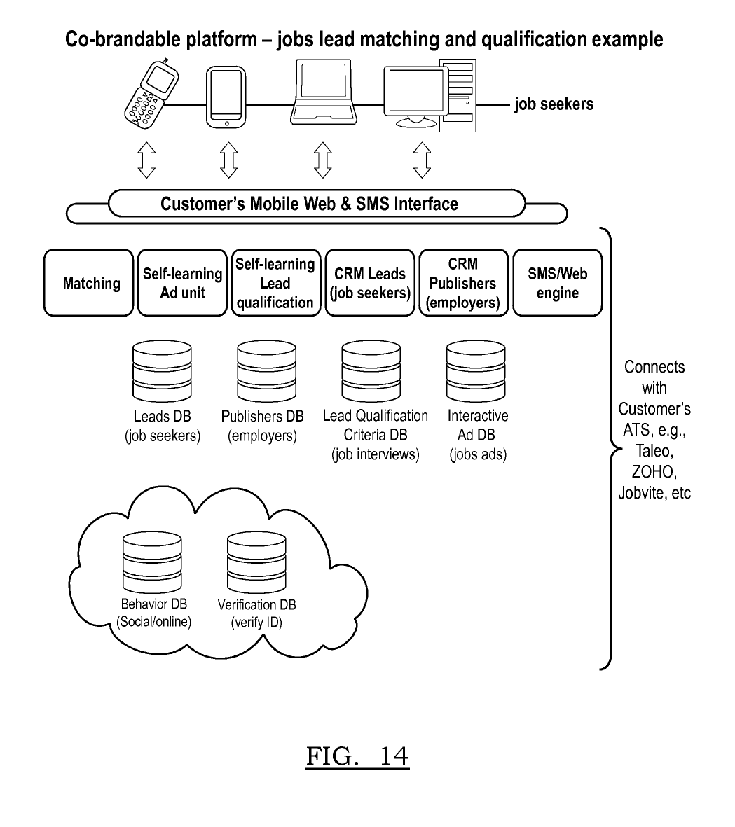

FIG. 14 depicts a simplified system architecture diagram of an exemplary digital advertising platform, in accordance with one or more embodiments of the present disclosure. In this particular example, client-server system architecture for a co-brandable job recruitment advertising platform is illustrated. As shown the system architecture may include a number of server components and modules for matching and qualifying leads, a number of databases for aggregating and storing relevant data, and one or more interfaces for communicating with various system clients, including job seekers and employers.

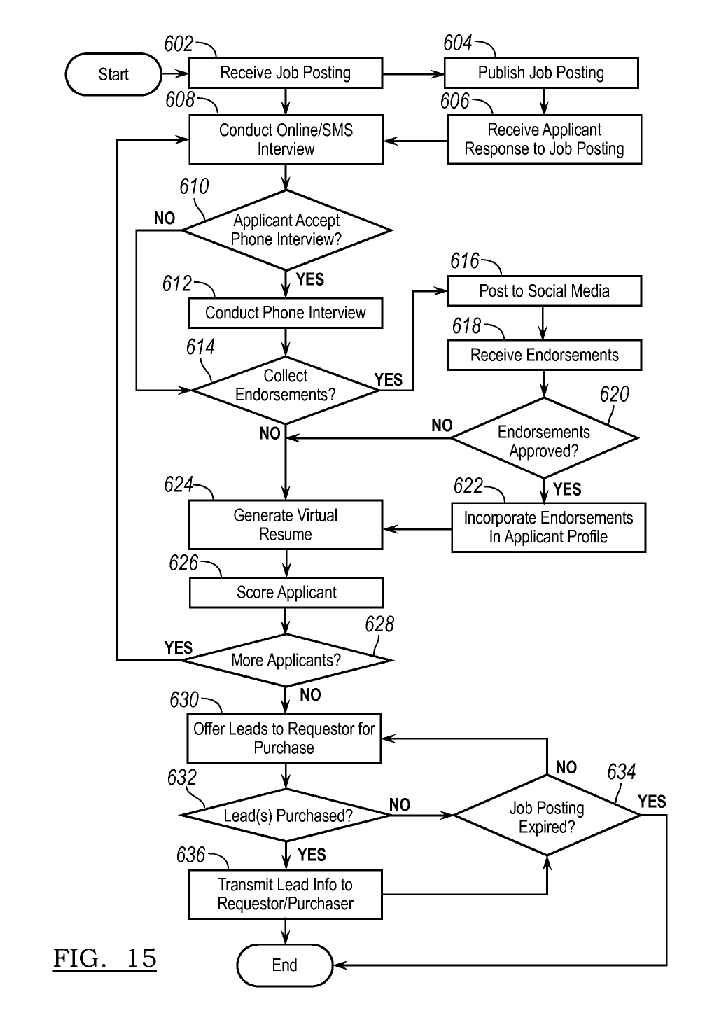

FIG. 15 is a simplified flow diagram depicting one exemplary process 600 for generating qualified leads in an online job recruitment advertising platform. It should be understood that one or more steps may be modified, rearranged, substituted or omitted depending on a particular implementation without departing from the scope of the present disclosure.

At step 602, the advertising component 32 receives a job posting. In an example, a lead requester 26 such as an employer may log into a job board website, and may use a form such as the web form 60 described above with respect to FIGS. 3 and 3B to post a job. The lead requester 26 may accordingly provide information such as a description of the job, various details relating to the position and its requirements, and questions to be answered by potential applications.

At step 604, the advertising component 32 publishes the job posting. For example, once the lead requestor 26 has completed the general details section 62 and each user selectable inquiry section 64 of the web form 60, the advertising request may be submitted online where it can be received by the advertising component 32. FIG. 4 depicts an exemplary online screen 74 that may be displayed once the advertising request has been submitted.

At step 606, the advertising component 32 receives an applicant response to the job posting. In an example, an applicant responder 28 may interact with an interactive advertising unit 34 for the published job posting. As discussed above, FIG. 5 depicts an exemplary interactive advertising unit 34 for a job board posting running on a website.

At step 608, the advertising component 32 conducts an online or SMS interview. In an example, if the interactive advertising unit 34 is running on a media website, a responder 28 may interact with the advertising unit without leaving the site. In another example, the advertising unit 34 may provide real-time computerized interactions with responders 28 over alternative communication mediums, including telephone, SMS, IM services, and the like.

At step 610, the advertising component 32 determines whether the applicant responder 28 accepts a phone interview. In an example, and as shown in FIG. 6, the advertising unit 34 may instruct the job applicant responder 28 to enter a telephone number where the applicant can be reached into a numerical field 84. If the responder 28 enters his or her telephone number into the numerical field 84 and presses call now, control passes to step 612. Otherwise, control passes to step 614.

At step 612, the advertising component 32 conducts the phone interview. For example, once the telephone number is submitted, the advertising unit 34 may call the applicant to continue the interview process. The voiced-based responses to the phone interview questions may be recorded and analyzed by the advertising component 32 along with the text-based responses.

At step 614, the advertising component 32 determines whether to collect endorsements. For example, the advertising component 32 may request endorsements from validators 30 to include in the responder's profile. In certain implementations, responders 28 may be given the option of seeking endorsements to bolster the responder's profile. If endorsements are requested, control passes to step 616. Otherwise, control passes to step 624.

At step 616, the advertising component 32 posts to social media. For example, if a responder 28 desires to obtain endorsements, the advertising component 32 may facilitate the endorsement process by engaging a responder's acquaintances. For example, the advertising component 32 may request endorsements from a responder's contacts using a social media platform. Upon receiving authorization, the advertising component 32 may post a message on a responder's behalf seeking endorsements from the responder's social media contacts.

At step 618, the advertising component 32 receives endorsements. In an example, the advertising component 32 may post the message 86 on a social networking site 88 on the behalf of the job applicant responder 28 informing the applicant's friends or other social media contacts about the job the applicant is seeking, as shown in FIG. 8. The advertising component 32 may also repurpose the comments section to collect endorsements from the social media contacts of the job applicant responder 28.

At step 620, the advertising component 32 determines whether the received endorsements are approved. In an example, the responder 28 may be provided the opportunity to accept or reject each endorsement or reference. The option to accept or reject third party feedback may also depend on the particular implementation of the advertising system described in the present disclosure. For instance, while the option to accept or reject endorsements may be sensible in a job recruitment advertising platform, it may not be for other vertical advertising units. If the received endorsements are approved, control passes to step 622. Otherwise, control passes to step 624.

At step 622, the advertising component 32 incorporates the received and approved endorsements into the applicant profile. In an example, accepted endorsements may be incorporated into a profile of the responder 28 by the advertising component 32 for potential review by a lead requestor 26.

At step 624, the advertising component 32 generates a virtual resume for the applicant responder 28. In an example, the advertising component 32 may include a profile building module 44, and may use the profile building module 44 to build a responder profile for the applicant responder 28. The profile may include information relating to the interactions between the advertising unit 34 and the responder 28, including text-based and/or voice-based responses 130 to the pre-screening inquiries 66, as well as identified voice characteristics 106, if applicable.

At step 626, and similar to as discussed above with respect to step 320, the advertising component 32 scores the applicant responder 28. In an example, the responder 28 may be evaluated and scored based on responses given to the advertising unit 34. Moreover, if endorsements were collected, the endorsements may be factored into the scoring algorithm. Yet further, if voice characteristics 106 were specified for the advertisement, the voice characteristics 106 of the voice answers 100 may be factored into the scoring algorithm according to the voice identification performed by the voice analyzer module 108.

At step 628, the advertising component 32 determines where there are additional applicants to process. For example, the advertising component 32 may determine whether additional applicant responders 28 have responded to the published job posting. If additional applicant responders 28 have responded, control passes to step 608.

At step 630 and similar to as discussed above with respect to step 345, the advertising component 32 offers leads to the requester for purchase. The presentation of leads may include a preview only of each lead's profile or may include full access to each lead's entire profile. If a lead looks promising, the lead requestor 26 may be given the opportunity to purchase the lead's contact information for follow-up. Alternatively, a purchaser can bid on the lead's price. In this regard, several purchasers may, in effect, compete for the same lead.

At step 632 and similar to as discussed above with respect to step 350, the advertising component 32 determines whether leads are purchased. If the purchase of one or more leads has been requested, the advertising component 32 may then transmit lead contact information to the lead requestor 26, at step 636.

At step 634 and similar to as discussed above with respect to step 360, the advertising component 32 determines whether the job posting has expired. An advertising unit 34 may expire for any number of reasons. One such reason may occur when the lead requestor 26 informs the advertising component 32 that additional leads are not required. For instance, an employer may indicate that a job position for which leads were requested has been filled. Thus, the need for additional leads may be negated. Other reasons to expire an advertising unit may be due to such things as the number of pending leads that have not been reviewed yet or the amount of revenue the advertising unit has generated. If the advertising component 32 is still active, the process may return to step 630 for the presentation of additional leads. If no leads are purchased at step 632, the method may proceed directly to step 634 for a determination as to whether the advertising unit 34 has expired.

At step 636 and similar to as discussed above with respect to step 355, the advertising component 32 transmits the load information to the requester or purchaser. After step 636, control may pass to step 634, or if the advertising component 32 has already determined the job posting to be expired, the process 600 ends.

FIG. 16 shows an exemplary schematic of the different components of the voice analyzer module 108 and how the input from users of the system (e.g., recruiters, loan approval officers, law enforcement officers, or other types of lead requesters 26) may be combined with the input from the general public via the feedback interface 120 or another interface such as a general web interface. The voice analyzer module 108 may be configured to perform a feature identification of a received voice segment to recognize physical characteristics 116 of the voice segment. The voice analyzer module 108 may also determine paralinguistic voice characteristics 106 of voice segments according to the physical characteristics 116 of the voice segments. The voice analyzer module 108 may also indicate a match status of the voice segment according to a comparison of the physical characteristics 116 and the paralinguistic voice characteristics 106 of the voice segments to desired characteristics of matching voice segments.

In an example, voice segments, such as voice-based responses 130 from applicant responders 28 may be provided to the voice analyzer module 108 for analysis, such as by the advertising component 32, and may be stored in the structured voice database 132. The classification engine 134 may receive the voice-based responses 130 from the structured voice data database 132, and perform clustering of the voice-based responses 130 according to their physical characteristics 116, such as dB, pitch, and inflection. A sound wave is the propagation of a disturbance of particles through an air medium, or, more generally, any medium, without the permanent displacement of the particles themselves. Accordingly, the physical characteristics 116 of a voice segment, such as a voice-based response 230, may refer to the properties or quantities associated with the sound waves of the voice segment, e.g., the “acoustic medium” of the voice segment.

The learning engine 136 may utilize feedback from cloud-based validators 110 and the lead requesters 26 to associate the classified voice-based responses 130 with paralinguistic voice characteristics 106 corresponding to the clustered group of voice-based responses 130. As mentioned above, paralinguistic voice characteristics 106 may refer to aspects of spoken communication that do not involve words, and may, for example, add emphasis or shades of meaning to the words and content of what a speaker of the voice segment may be saying.

Accordingly, the data sources may be used to map subjective voice characteristic 106 input (e.g., how a specific voice-based response 130 or other voice sample makes someone feel) with the physical characteristics 116 of that specific voice-based response 130 or other sample. The information may then be saved in the structured voice data database 132, and used in identifying the voice characteristics 106 of additionally-received voice-based responses 130. Thus, when voice characteristics 106 are specified by the lead requesters 26 for an advertising unit 34, the information of the structured voice data database 132 may be used for matching purposes to determine which voice-based responses 130 match the voice characteristics 106 specified for the advertising unit 34 by the lead requesters 26.

FIG. 17 is a simplified, exemplary diagram of using various sources of declared and observed information to generate potential matches 148 using a matching engine 154, in accordance with one or more embodiments of the present disclosure. As mentioned above, the system may use both declared information and observed information as part of its lead generating and matching technology. Declared information may include, for instance, age, skills, work history, income level, address, or the like (e.g., when answering a job application questionnaire or a health insurance questionnaire). In an example, the declared information may be entered into a worker or subject interface 150 (such as that provided by adaptive interactive advertising units 34) constructed according to input received to employer interface 152 (such as the web form 60). Observed information may include such information as location (based on network engagement information indicative of location of the device used by the person being qualified as a lead), internet browsing history or other network traffic, social networking behavior, speed at which the individual answers a pre-qualification questionnaire (e.g., a job application), and, as discussed in detail herein, voice pattern, inflection, pitch and tone.

One or more embodiments of the present disclosure relates to using observed information gleaned from voice or speech physical characteristics 116 (e.g., inflection, pitch, tone, frequency, etc.) as an aspect of a matching engine 154 for generating matches 148 or for other lead qualification purposes. Using job recruitment as an example, upon collecting thousands of voice recordings from responders (namely, job applicants answering automated phone interviews), the system may be configured to identify patterns based on the physical characteristics 116 of the voice recordings, independent of the content of the speech of the voice records. For example, people that recruiters think are a good fit for a telemarketing job (e.g., where somebody needs to have voice characteristics 106 such as to be energetic, pleasant, easy to understand, etc.) may share similar physical characteristics 116 that tend to fit a distinctive sound wave pattern, pitch, inflection, compression, amplitude, etc. On the other hand, people selected by recruiters as a good fit for customer service (e.g., where the ideal candidate needs to have a calming tone when dealing with angry customers) may have a different combination of sound wave pattern, pitch, inflection, compression, amplitude, etc.

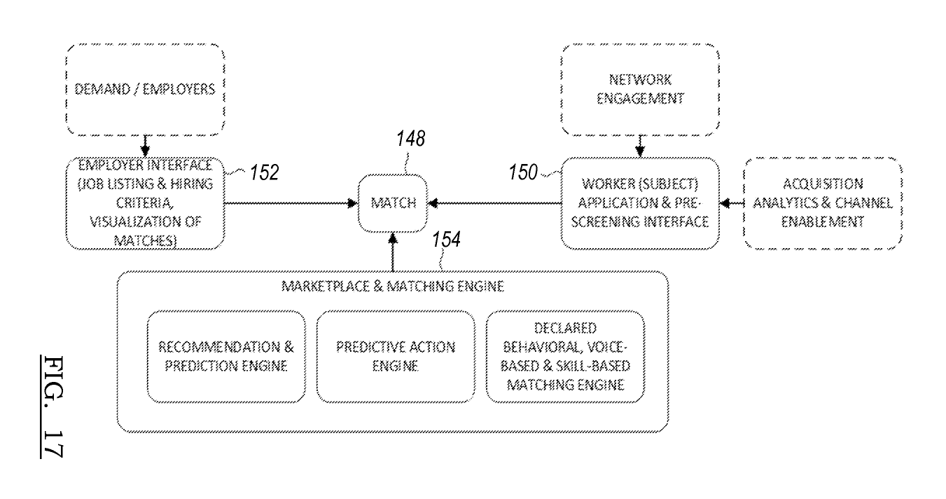

FIG. 18 shows an exemplary sound wave pattern of a high energy speaker in comparison with a natural conversational sound pattern. In the example, the natural conversation inflection and pattern 112 may be seen as having a relatively more consistent and lower amplitude than that of the high energy inflection and pattern 114 (e.g., of a telemarketer in an example). As some other examples of physical characteristics 116 that may be quantifiable by the voice analyzer module 108, the voice analyzer module 108 may be configured to identify amplitude 116-A, wavelengths 116-B, compression 116-C, pitch 116-D, and inflection 116-E within the patterns 112, 114.

As some examples of physical characteristics 116, amplitude 116-A is a measurement of voice signal and may be mapped to a sound wave according to a maximum absolute value of a sound wave's oscillation. Energy is a measurement of amplitude squared and may be mapped to a sound wave according to a phase of a Fast-Fourier Transform of the sound wave squared. Perceived pitch 116-D relates to a perceived fundamental frequency of a sound and may be mapped to a sound file as the lowest frequency found in the sound wave. Fundamental frequency relates to the reciprocal of time duration of one glottal cycle (a strict definition of “pitch”). Fundamental frequency may be mapped to a sound file as the lowest frequency found in the sound wave. Formants are resonance frequencies of the vocal tract, and may be mapped to data as peaks in the acoustic frequency spectrum of a sound file. Bandwidth refers to the width of a voice sound file's Fourier Transform, and may be mapped to the sound file as the range of frequencies between low and high pass cutoff frequencies used for sound file analysis.

In an example, the voice analyzer module 108 may utilize self-learning algorithms and adaptive interactive advertising units 34 to learn from these selections made by lead requesters 26 (e.g., recruiters, advertisers, etc.) who are making subconscious choices on which one is the best candidate (lead). This may add another dimension to matching algorithms, where the voice analyzer module 108 may be configured to identify the best match (e.g., qualified lead) based on a learned mapping of physical characteristics 116 (such as voice tone, pitch, sound wave pattern, inflection, or the like) to voice characteristics 106 (e.g., calming tone, upbeat voice, etc.) chosen by lead requesters 26, regardless of the content (context of the words spoken) or regardless of the language spoken. Thus, similarity of voice recordings to the voice recordings of responders 28 chosen by lead requesters 26 may be a source of information that may be used to train the system 10 to identify other similar voice recordings as also being desirable.

The voice characteristics 106 may include various categories of attributes. Speaker state voice characteristics 106 may refer to attributes of a speaker that change over time (such as affection/deception/emotion, interest, intoxication/sleepiness/stress/zest, etc.). Speaker trait voice characteristics 106 may refer to characteristic that are relatively permanently associated with a speaker (e.g., age/gender, likeability, personality, etc.). Acoustic behavior voice characteristics 106 may include non-linguistic vocal outbursts during speech (such as sighs/yawns/laughs/cries/coughs, hesitations, consent, etc.). Acoustic affect voice characteristics 106 may include non-linguistic affect carried in the speech (such as that a voice sounds pleasant or cheerful, that a voice sounds trustworthy, that a voice sounds deceitful, etc.) Elicited emotion voice characteristics 106 may include immediate listener reactions upon hearing a speech segment (such as that a listener feels that the speaker is energized/happy/joyful, annoyed/agitated, trustworthy/reliable/dependable, etc.).

In the specific case of the recruiting industry, recruiters may learn from years of experience which speech or voice characteristics 106 can be more effective for a telemarketing worker or for a front desk employee at fast food chain. This knowledge is often wasted as it is not easy to document or transfer to the organization. The advertising component 32 of the present disclosure may capture this knowledge by learning from many recruiters, across different companies, states, languages, or the like, and may tune the algorithm that qualifies leads to incorporate voice-analysis to help identify the best matches for specific jobs. This technology can be also applied to other industries. For example, voice analysis and matching may be employed to match people for romantic purposes (where people make subconscious choices based on voices they find more or less attractive) or for career selection purposes, among many other purposes.

The tone of voice reveals more things than one may think, and says more than the mere meaning of the words spoken. In the law enforcement industry, banking industry and recruiting industry, “body language” is often relied on for gathering information. Body language is generally defined as the process of communicating nonverbally through conscious or unconscious gestures and movements. There are characteristics of the human voice that complement the verbal communication. In this context, how things are said may be as important as what is been said.

Many times, though not noticing, when humans say something, they send two messages: one with the content of the spoken word and one with the tone in which it is said. The two messages may sometimes conflict. For example, when one asks another person if he or she is angry, the person may respond in the negative by increasing the volume or pitch of the voice, which is often registered by humans as an angry “no.” In this case, the content of the verbal response “no” does not match the signal interpreted by the recipient of the message. The recipient of the message may discard the content or “what was said” and rather rely in the tone of voice used as a more accurate answer to the question asked. As another example, saying “please” in a tone of complaint or impatience by raising the tone or increasing the inflection and volume (energy level) is different compared to saying “please” in a calm voice that is characterized by minimal inflection, lower volume or energy level, and a lower pitch.

The application of this voice analysis and matching technology can also be used to detect levels of conviction and connection in a person's voice—two key elements in building trust, rapport and a meaningful dialog. These elements may be important in the job recruitment industry. For example, when recruiting personnel that needs to interact with customers on a daily basis, high levels of conviction and connection may be a pre-requisite. The level of conviction can be also used as a proxy to detect if someone is being truthful.

Additionally or alternately, crowd-sourced information may be used as a source of information to train the voice analyzer module 108 to identify other similar voice recordings as also being desirable. Accordingly, one or more embodiments of the present disclosure provides matching and lead pre-qualification based on predicted human listener emotion elicited by the paralinguistic aspects of a speech segment. The voice analysis and matching algorithms of the voice analyzer module 108 may classify different measurable physical characteristics 116 of the voice into emotional categories or other voice characteristics 106 that are the foundational elements of how humans connect with others in different cultures. The system may be aided in doing so through crowdsourcing and self-learning from all system users in a network. For instance, the advertising component 32 may utilize cloud-based validators 110 configured process and aggregate millions of voice responses from individuals of different cultures, academic background, socio-economic segment, gender, age and other demographic and psychographic characteristics and classify those voices by measurable paralinguistic characteristics 116. In some examples, to ensure diversity of the cloud-based validators 110, the system 10 may request demographic information from the cloud-based validators 110. The system 10 may use the received demographic information to construct a set of cloud-based validators 110 having demographics consistent with the population at large, or may weigh the responses of the cloud-based validators 110 according to their demographic percentages of the population at large, as some possibilities.

A feature of this technology may include mapping the impact a sound clip makes on the perception of a human being of the speaker. Detecting emotion from acoustic data in a paralinguistic manner may typically involve two processes: (1) converting audio samples into data points (e.g., as performed by the classification engine 134), and (2) searching for a variety of vocal cues that emerge (e.g., as performed by the learning engine 136), indicating various “basic” emotions. Not only may emotions be pulled from acoustic data, but the intensity of emotions can also be determined with relative accuracy.

Generally, pitch is the major cue used in analyzing emotion from audio samples. The classification engine 134 may accordingly utilize a number of methods to turn direct acoustic data of the voice-based responses 130 into pitch contours, from which range and mean can be extracted and analyzed. For example, the classification engine 134 may utilize methods including transformations, slicing audio samples into much smaller snippets, or the like. Intensity and speech rate may also provide common cues indicative of a variety of emotions. For example, the voice analyzer module 108 may perform transformations, such as turning voice segments into pitch contours and taking various statistics such as max, min, standard deviation, time-window averages, on whole segments or on snippets of the segment. Some features that have demonstrated effectiveness for recognizing speaker emotions include: fundamental frequency, and its statistics such as min, max, mean, and standard deviation over time; pitch contour; speech signal amplitude; frequency spectrum energy distribution; and durations, such as proportion of pauses, duration of syllables, syllable rate, and total duration. In addition to effectiveness, the voice analyzer module 108 may determine associations between the voice features and voice segment emotions. For example, the presence of anger in speech segments may be associated with a rise in fundamental frequent and amplitude, whereas despondency may be associated with a decreased syllabic rate. As another example, acoustic features for affect recognition have been experimented and demonstrated to outrank “classic” features for affect recognition tasks. Moreover, the use of paralinguistic features has also been demonstrated effective to assist other features to further disambiguate affect.

As discussed above, voice-based responses 130 to interview questions may be recorded as voice segments, such as in a wave or another audio file format. In an example, and as illustrated above with respect to FIGS. 6 and 9, interviewees may be requested to answer the question “greet me as if I am a customer.” Metadata may be associated with the voice segments, such as job categories for which the responder 28 applicants are applying, and the interview prompts or other pre-screening inquiry 66 to which the employers or other lead requesters 26 asked the applicants to respond. The metadata may be used to filter or otherwise classify the voice segments into groups to allow the voice analyzer module 108 to model the voice-based responses 130 according to groups of interview prompts. In many examples, however, the content of the metadata itself may not be included in the features for performing the modeling.

A collection of voice segments (e.g., for answering the example pre-screening inquiry 66) may be used as input data for the voice analyzer module 108. Based on the analysis, the voice analyzer module 108 may be able to, in an example, improve matching of responders 28 to lead requesters 26 that require interaction with customers and keeping the customers engaged, for example, a telemarketer, a retail store clerk, a frontline employee as a quick serve restaurant or a front desk associate at a hotel.

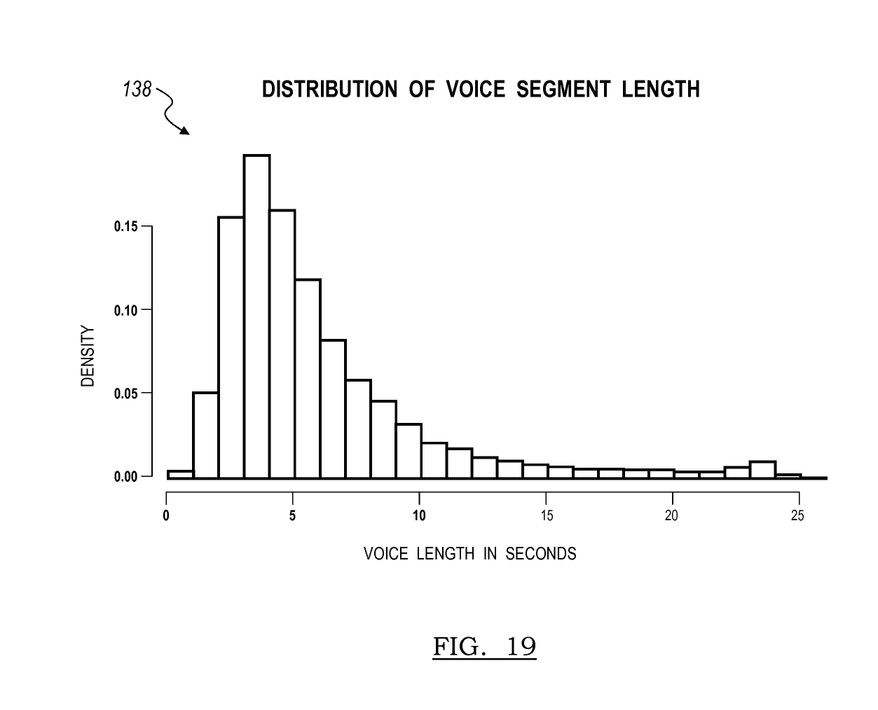

FIG. 19 illustrates an example distribution 138 of voice segment length for the collection of voice segments for answering the example pre-screening inquiry 66. Since the voice data are free-form speech recorded from job applicants or other responders 28, the received voice-based responses 130 may not have uniform range for the length of the recorded voice segments. In an example, the voice analyzer module 108 may be configured to discard voice segments of insufficient length (e.g., shorter than two seconds), as such samples may not provide enough evidence regarding qualifications of the applicants for employers to screen for further information.

A preprocessing component of the classification engine 134 may be configured to transforms the voice segments (e.g., in wave format) into various data elements indicative of physical characteristics 116 for feature classification. These data elements may include, as some possibilities: (i) the short-term Fast Fourier Transform per frame; (ii) the energy measures in frequency domain per frame; and (iii) the linear prediction coefficient (LPC) in frequency domain per frame. From there, the voice analyzer module 108 may construct a feature space of the physical characteristics 116 of the received voice segments for modeling purposes.

With respect to feature space construction for the physical characteristics 116 of the voice segments, to predict listener emotions (e.g., for the purpose of assisting employers to screen job applicants, at scale), the voice analyzer module 108 may utilize various categorization and definition of emotions. In an example, instead of taking any specific categorization and definition of one particular emotion (such as “happy”) and building model for it, the voice analyzer module 108 may utilize a starting point of predicting positive response vs. negative response, whereas positive response could be one or multiple of perceptions of “pleasant voice”, “makes me feel good”, “cares about me”, “makes me feel comfortable”, or “makes me feel engaged”.

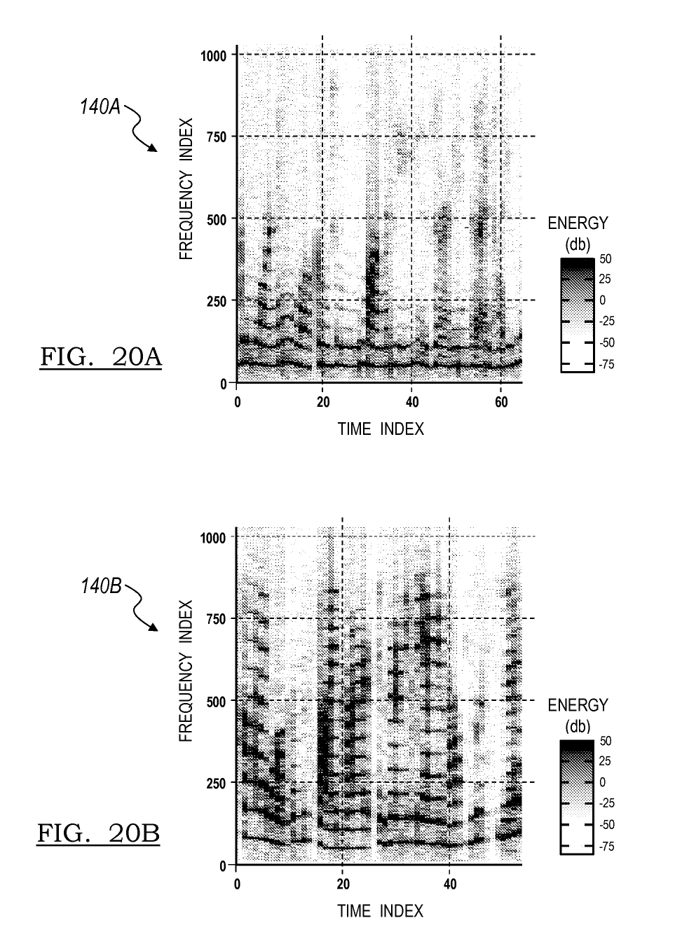

FIGS. 20A and 20B illustrate two sample voice segments from job applicants for the example pre-screening inquiry 66 (e.g., “Greet me as if I am a customer”), and their corresponding spectrograms. As illustrated, the sample voice segment spectrogram 140B of FIG. 20B includes an increased every level as compared to the sample voice segment spectrogram 140A of FIG. 20A. After listening to the voice segments, a listener may be able to notice the energy level difference in speakers and their potential perceptions.

The classification engine 134 may be further configured to perform clustering of the data (e.g., once transformed and sliced into audio snippets) to identify voice data sharing similar physical characteristics 116, such as frequency, pitch, and tone, as some non-limiting possibilities. Clustering may refer to the grouping of elements and features of data in such a way that data elements/features in the same cluster are more similar to one another with respect to one or more data properties than to those in other clusters. In an example, the clustering may be performed by creating a definition of similarity for audio samples, e.g., according to one or more of physical characteristics 116 of the voice data samples. When performing clustering, similarity may be measured by some distance measure that operates on a multidimensional space that the data representing the data resides.

As some examples of physical characteristics 116 dimensions and their combinations that may be utilized for clustering, the voice analyzer module 108 may utilize one or more of: (i) signal measurements such as energy, amplitude; (ii) statistics such as min, max, mean, standard deviation, on signal measurements; (iii) measurement window in time domain: different time size, entire time window; (iv) measurement window in frequency domain: all frequencies, optimal audible frequencies, selected frequency ranges; (v) distance metrics: dynamic time warping; and (vi) Euclidean algorithms such as hierarchical clustering, k-means clustering, or complete clustering.

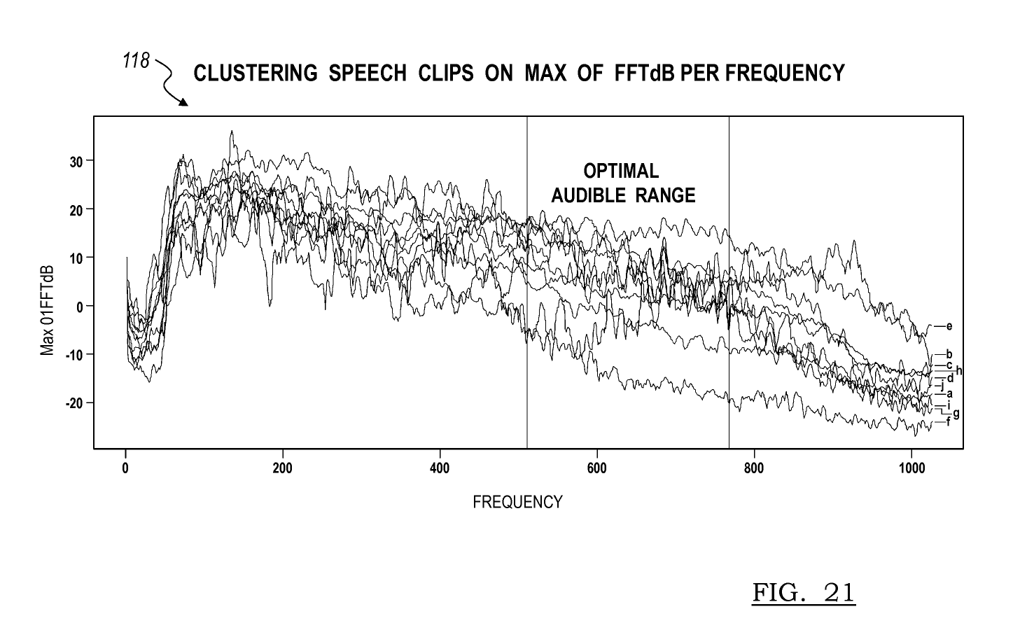

An example clustering 118 of ten speech clips by frequency performed by the classification engine 134 is shown in FIG. 21. As shown, each cluster is illustrated as a centroid of the cluster by maximum FFTdb in the frequency domain across voice segments. Since the clustering analysis is “unsupervised learning,” “manual” effort may be used to validate the results. In an example, the classification engine 134 may be configured to support manual listening to the sound clips that were clustered together to validate whether the clustering results were meaningful. Based on the listening test, reasonable similarities may be seen within each cluster and dissimilarities may be seen between clusters. In an example (not shown in FIG. 21), the learning algorithms may identify two clusters from the speech clips, one for highly energetic voice clips and one for relatively low energy clips.

The clustering analysis shows that the sound clip data has reasonable predictive power, based on which, the predictive modeling approach can be expected to produce positive results. The clustering may be validated through gathering feedback from a balanced sample (matching census data profile) of humans on a series of segments of audio clips, exposing them to clusters of clips that correspond to different emotions. In clustering, the voice analyzer module 108 may utilize a clustering algorithm configured to yield good results and a number of clusters that are appropriate for the data. Statistical properties that are desirable for “good” clustering results may include compactness, well-separatedness, connectedness, and stabilities, as some possibilities. In an example, the clustering may utilize a hierarchical clustering algorithm with five clusters to provide good results. In another example, the clustering may utilize K-means clustering with nine clusters to provide good results.

The learning engine 136 may be configured to receive clusters of data identified by the classification engine 134 as sharing the similar physical characteristics 116. Using the clustered data, the learning engine 136 may be configured use learning algorithms to receive input from humans interactions with the cloud-based validators 110 to map ranges and combination of ranges of audio signals (i.e., physical characteristics 116) to emotional impact or other voice characteristics 106.

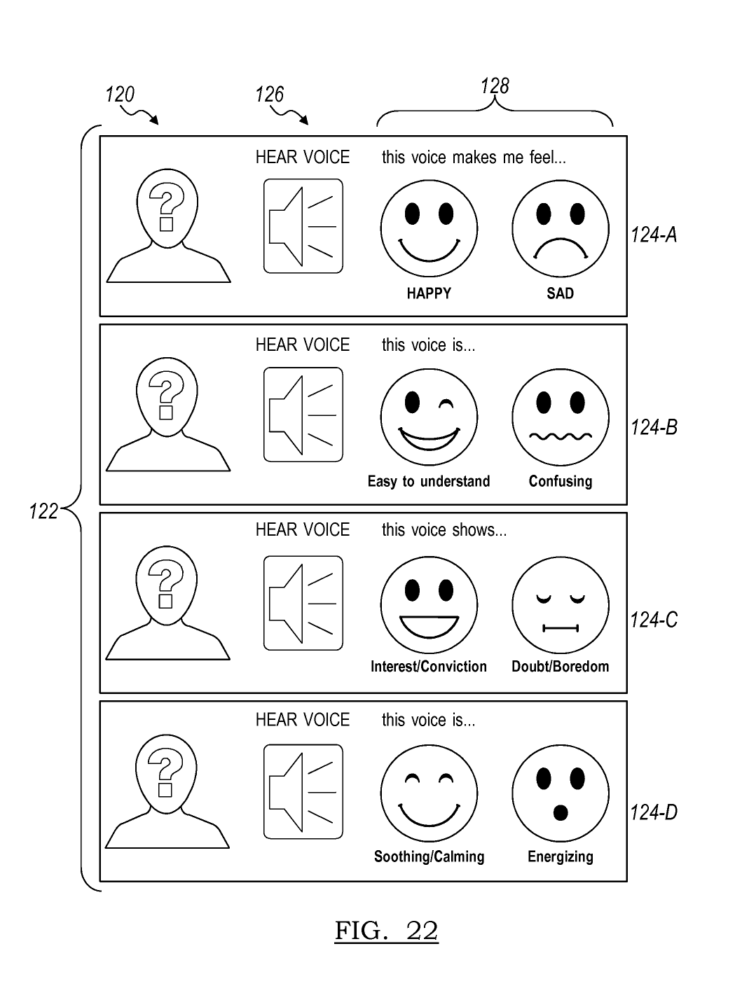

FIG. 22 illustrates an example simple-to-use feedback interface 120 that may be employed to allow the system to receive information regarding what voice characteristics 106 are to be associated with which voice samples. In an example, the learning engine 136 may provide an interface, such as the feedback interface 120, by way of a website for cloud-based validators 110 to use to provide feedback with respect to the clustered data. The interface 120 may include a listing 122 of one or more voice records 124 for classification. For each voice record 124, the interface 120 may include a play control 126 that, when, pressed, allows the user to hear the corresponding voice record 124 to be classified, and classification controls 128 that, when pressed, allow the user to specify which voice characteristics 106 are presented in the played voice record 124. In an example, the classification controls 128 may receive feedback from a user regarding whether a voice record 124 makes a listener feel happy or sad, is spoken an easy to understand or confusing voice, shows interest/conviction or doubt/boredom, and is soothing/calming or energizing.

Using the mapping, voice-based responses 130 from responders 28 may be classified into the clusters of the learned data of the structured voice database 132, and associated with voice characteristics 106 corresponding to the clusters into which the voice-based responses 130 are similar. Thus, signals extracted from same audio clips may be mapped to voice characteristics 106, such as rate of speech, easiness to understand, energy level, etc. Accordingly, the voice analyzer module 108 may be used to classify the voice characteristics 106 of the voice-based responses 130 of the responders 28, which may allow the scoring component 48 to score the responders 28 as a potential leads based on voice characteristics 106 of the voice-based responses 130 desired for qualified leads.

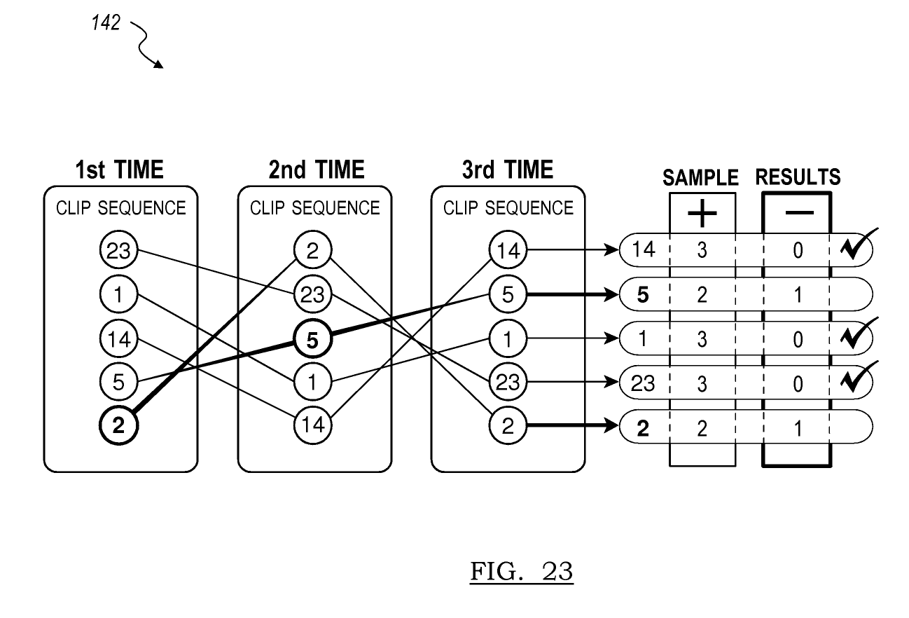

FIG. 23 illustrates an example verification 142 of voice samples by listeners for consistency. In an example, each responders 28 may be requested to listen a set of voice clips (e.g., 15 clips), and provide feedback with respect to the played clips. However, rather than playing all unique clips, the system may be configured to play clips multiple times within the set of voice clips (e.g., a random ordering of 5 clips, such that each clip is played three times). Thus, for the input from the responder 28 to be considered by the voice analyzer module 108 (e.g., as provided via the feedback interface 120), the responder 28 would have to provide a consistent rating to the voice clip each time it is played during the verification. As shown, clips 1, 14 and 23 would be considered to be “verified” voice-based responses 130 for analysis. However, clips 2 and 5 display inconsistent results and would not be considered to be “verified” voice-based responses 130 for analysis.

Supervised learning techniques infer functions from observed data and associated outcome labels so that the inferred functions work correctly on unseen data to predict their outcome. Building prediction models typically demands training datasets that represent ground “truth” of the world to be modeled. Conventional approaches to predictive modeling usually employ collecting training data through human labeling (labeled data). In modeling listener emotional response to voice segments, absolute ground truth may be unavailable, as the voice analyzer module 108 may not have a complete mathematical formulation mapping from voice segment physical characteristics 116 to emotion or other voice characteristics 106. Similarly, the voice analyzer module 108 may be unable to completely rely on human labeling, as a human labeler's emotional state may affect the results and can be elusive to precisely capture by the labeler himself or herself. Nevertheless, the described clustering analyses performed on the voice segments from job applicants and the corresponding extracted feature data may provide reasonable differentiating power to map the voice segments into clusters that might correlate with listener responses. Moreover, the predictive modeling built on top of clustering insights and iterative feedback from listeners may learn and improve the provided results.

Accordingly, the voice analyzer module 108 may utilize a prediction models using support vector machine and logistic regression algorithms, where the training data is a combination of clustering results and human rating. In an example, the voice analyzer module 108 may utilize the model to predict match results, such as binary outcomes (positive vs. negative) and numerical scores for further classification of listener emotions.

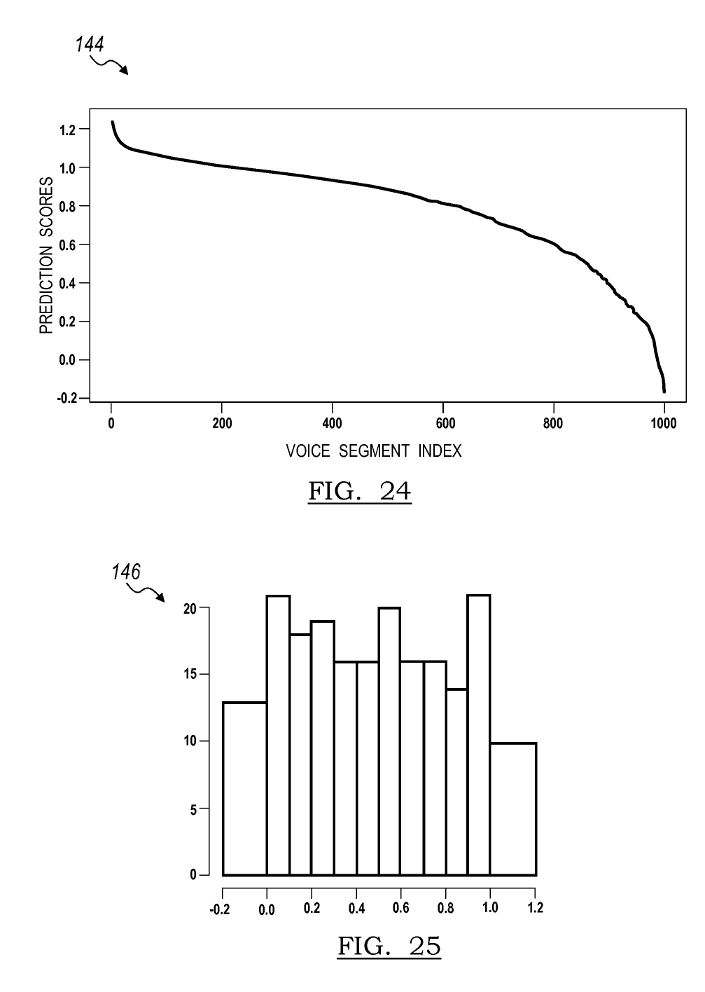

FIG. 24 shows a distribution 144 of the predicted scores on voice segments by a model of the voice analyzer module 108. To generate the scores, the voice analyzer module 108 may transform each voice segment into a set of numerical matrices representing a discrete Fourier Transform of the voice segment energies by time frame and by frequency. The voice analyzer module 108 may further apply a mathematical model to those matrices to arrive at a score corresponding to the voice segment. In general, as illustrated a higher score indicates that the model predicts a higher likelihood that the voice segment will generate a positive response from a listener. However, as each voice segment is amazingly rich in what it expresses, while higher scores may generally refer to more positively indicated voice segments, the model scores should not be treated as an absolute sorted order of voice segments in which the voice samples would be positively responded to by the listeners.

Another way to explain this phenomena of “relativism” is that one can build another model using similar training data and the resulting score curve might have different velocity, which could impact different bucketization if thresholds are not modified accordingly. For instance, FIG. 25 shows the histogram of bucketization 146 by an alternate model to that illustrated in FIG. 24, in which scores for the voice segments are bucketized according to the prediction scores. Accordingly, voice segments within each bucket may be considered as relatively similar in terms of how they would be responded to by the listeners.

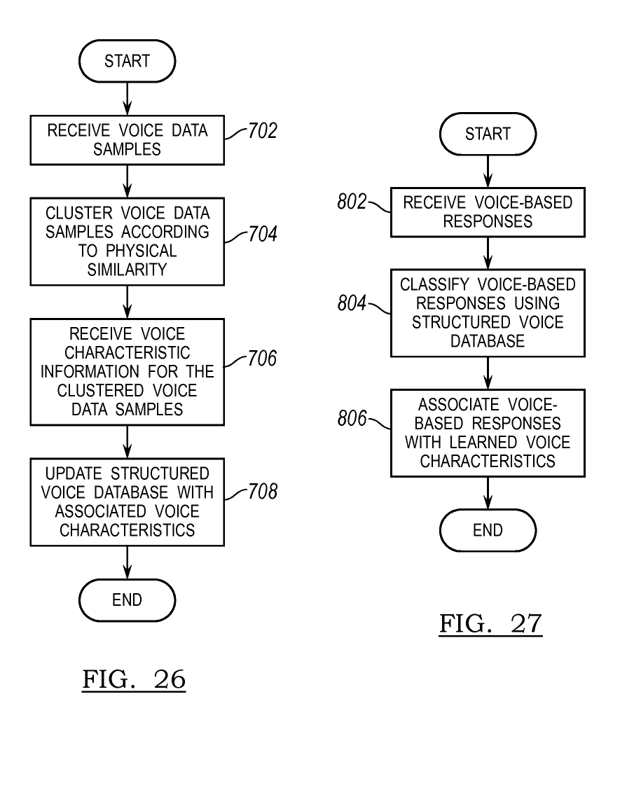

FIG. 26 illustrates an exemplary process for utilizing the voice analyzer module 108 to associate voice characteristics 106 with voice-based responses 130 provided by responders 28 to interactive advertising unit 34.

At step 702, the voice analyzer module 108 receives voice data samples. In an example, the voice data samples may include voice-based responses 130. Additionally or alternately, the voice data samples may include other voice data suitable for training the voice analyzer module 108, such as voice samples of speakers having different accents, or speaking different languages. The voice analyzer module 108 may store the voice data samples in the structured voice database 132 for analysis.

At step 704, the voice analyzer module 108 clusters the voice data samples according to similarity of one or more of physical characteristics 116 of the voice data samples. In an example, the classification engine 134 of the voice analyzer module 108 clusters the voice data samples according to physical characteristics 116 including one or more of frequency, pitch, and tone. An example clustering of voice data samples is illustrated with respect to FIG. 21. The classification engine 134 may further store the clustering of the voice data samples in the structured voice database 132.

At step 706, the voice analyzer module 108 receives voice characteristic 106 information for the clustered voice data samples. In an example, the learning engine 136 may utilize physical characteristics 116 of the voice data samples of voice recordings of responders 28 chosen by lead requesters 26 to train the voice analyzer module 108 in the physical characteristics 116 indicative of voice characteristics 106 deemed desirable by the lead requesters 26. In another example, the learning engine 136 may provide an interface, such as the feedback interface 120, by way of a website for cloud-based validators 110 to use to provide feedback with respect to the voice characteristic 106 for voice data samples for which physical characteristics 116 have been clustered.

At step 708, the voice analyzer module 108 updates the structured voice database 132 with the associated voice characteristics 106. In an example, the learning engine 136 may store the voice characteristics 106 associated with the clustered voice data samples in the structured voice database 132. After step 708, the process 700 ends.

FIG. 27 illustrates an exemplary process for utilizing the voice analyzer module 108 to identify voice characteristics 106 associated with voice-based responses 130 provided by responders 28 to interactive advertising unit 34.

At step 802, the voice analyzer module 108 receives voice based responses 130. In an example, the voice based responses 130 may be received from an applicant responder 28 responding to pre-screening inquiries 66 of a lead request. The voice-based responses 130 may be provided, for instance, during a phone interview 612 as discussed above.

At step 804, the voice analyzer module 108 classifies the voice-based responses 130 according to the structured voice database 132. In an example, the voice analyzer module 108 may match the physical characteristics 116 of the received voice-based responses 130 with the physical characteristics 116 of other voice-based responses 130 or other voice data samples in the structured voice database 132.

At step 806, the voice analyzer module 108 associates the voice-based responses 130 with the learned paralinguistic voice characteristics 106. In an example, the voice analyzer module 108 may associate the voice-based responses 130 with the paralinguistic voice characteristics 106 of the matching voice-based responses 130 or other voice data samples in the structured voice database 132. After step 802, the process 800 ends.

Thus, based on statistical processing and modeling, the machine learning algorithms can detect natural clusters of data that can be further refined by a system that collects the input of millions of members to scientifically classify large datasets of voice records based on subjective voice characteristics 106, such as happiness, sadness, boredom, engagement, and the like. The voice analyzer module 108 may accordingly map this data to a level of conviction and connection that is better suited for specific professions, careers or jobs. Alternatively, the same type of data may also be used for matching of romantic purposes, or for analyzing level of trustworthiness for the law enforcement or banking industries.

In the job recruitment context, for example, the voice analysis component may provide an objective analysis of whether or not the tone of voice will help an employer to serve better their existing or potential customers, or if the specific voice is easy to understand and commands authority, something crucial in the construction and manufacturing industries where clear verbal communications are a matter of safety at work. As a result, recruiters can more quickly identify workers that are likely going to perform better in a sales, marketing or front desk position at a restaurant, hotel, call center or retailer, because their voice keeps people engaged and interested. Or people with a calming a soothing voice could be better for customer service positions and appropriately matched. It should be noted that the demographic characteristics of the listener may matter. For example younger demographics (18-29 years old) or people in the lower income brackets of less than $29K/year have a more strict criteria of what the find as a pleasant or engaging voice. The practical implication is that algorithms can be fine-tuned to define “engaging or pleasant voice” based on the age of the target audience these individuals will speak to. Hence a retailer that caters to a younger demographic might need individuals with a voice characteristic different than a retailer that caters to older demographics.

Additionally, there may be a significant drop in emotional response to voices of similar characteristics, when the listener is exposed to segments longer than five seconds. Thus, a practical implication may be, for example, defining an optimal length of customer greeting for a telemarketing or customer service firm or for a retailer, depending on the demographic they serve. Further, using the voice analyzer module 108 it may be identified that no positive or negative correlation found on the emotion elicited on the listener and the age, ethnicity (accent) or education level of the speaker.

As another aspect, a slight bias towards female voices may be noted, meaning that voices of similar characteristics but from a female speaker ranked on average 11% better than the ones from male speakers. This additional observation may be used to additional input for the fine-tuning of the voice analyzer module 108. It should also be noted that consumer-validated responses may be fairly even-spread on the prediction of a non-engaging or non-interesting voice. This means that when the voice analyzer module 108 does not give a recommendation of a voice segment, it should be noted that no conclusion should be reached with respect to the results of negative end of the spectrum of the voice segments.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a computing device configured to
perform a feature identification of a received voice segment to recognize physical characteristics of the voice segment;
determine paralinguistic voice characteristics of the voice segment according to the physical characteristics of the voice segment; and
indicate a match status of the voice segment according to a comparison of the physical characteristics and the paralinguistic voice characteristics of the voice segment to desired characteristics of matching voice segments.

2. The system of claim 1, wherein the computing device is further configured to perform the feature identification by transforming the voice segment into data elements including one or more of (i) short-term Fast-Fourier Transform; (ii) frequency domain energy measure; and (iii) linear prediction coefficient in a frequency domain.

3. The system of claim 1, wherein the physical characteristics include at least one of sound wave pattern, pitch, inflection, compression, and amplitude.

4. The system of claim 1, wherein the paralinguistic voice characteristics include at least one of rate of speech, easiness to understand, and energy level.

5. The system of claim 1, wherein the system further comprises a database of structured voice data configured to maintain associations of clusters of voice segment data that share similar physical characteristics to paralinguistic voice characteristics, and the computing device is further configured to determine the paralinguistic voice characteristics of the voice segment by retrieving associated paralinguistic voice characteristics of clusters of voice segment data that share similar physical characteristics to the physical characteristics of the voice segment.

6. The system of claim 5, wherein the computing device is further configured to train the database of structured voice data to map paralinguistic voice characteristics to predictive feature combinations of physical characteristics.

7. The system of claim 5, wherein the computing device is further configured to train the database of structured voice data according to identified paralinguistic voice characteristic input received from a training user interface.

8. The system of claim 7, wherein the training user interface is provided to validator users by way of a web page in communication with the computing device.

9. The system of claim 1, wherein the computing device is further configured to:
receive, from a lead responder, a voice-based response to a pre-screening inquiry of a lead request, the voice-based response including the voice segment;
identify, from the voice segment, a textual answer to the pre-screening inquiry provided by the lead responder; and
score the lead responder as a potential lead in connection with the lead request based on the textual answer to the pre-screening inquiry and the match status of the voice segment.

10. A computer-implemented method comprising:
performing a feature identification of a received voice segment to recognize physical characteristics of the voice segment;
determining paralinguistic voice characteristics of the voice segment according to the physical characteristics of the voice segment; and
indicating a match status of the voice segment according to a comparison of the physical characteristics and the paralinguistic voice characteristics of the voice segment to desired characteristics of matching voice segments.

11. The method of claim 10, further comprising performing the feature identification by transforming the voice segment into data elements including one or more of (i) short-term Fast-Fourier Transform; (ii) frequency domain energy measure; and (iii) linear prediction coefficient in a frequency domain.

12. The method of claim 10, wherein the physical characteristics include at least one of sound wave pattern, pitch, inflection, compression, and amplitude.

13. The method of claim 10, wherein the paralinguistic voice characteristics include at least one of rate of speech, easiness to understand, and energy level.

14. The method of claim 10, further comprising:
maintaining, in a database of structured voice data, associations of clusters of voice segment data that share similar physical characteristics to paralinguistic voice characteristics; and
determining the paralinguistic voice characteristics of the voice segment by retrieving associated paralinguistic voice characteristics of clusters of voice segment data that share similar physical characteristics to the physical characteristics of the voice segment.

15. The method of claim 14, further comprising training the database of structured voice data to map paralinguistic voice characteristics to predictive feature combinations of physical characteristics.

16. The method of claim 14, further comprising training the database of structured voice data according to identified paralinguistic voice characteristic input received from a training user interface.

17. The method of claim 16, wherein the training user interface is provided to validator users by way of a web page interface.

18. The method of claim 10, further comprising:
receiving, from a lead responder, a voice-based response to a pre-screening inquiry of a lead request, the voice-based response including the voice segment;
identifying, from the voice segment, a textual answer to the pre-screening inquiry provided by the lead responder; and
scoring the lead responder as a potential lead in connection with the lead request based on the textual answer to the pre-screening inquiry and the match status of the voice segment.

19. The method of claim 18, further comprising:
receiving match criteria including a description of an advertisement, a selection of pre-screening inquiries, and a selection of paralinguistic voice characteristics;
publishing an interactive advertising unit online corresponding to the advertisement based on the match criteria; and
interacting, via the interactive advertising unit, with a plurality of responders to collect responder information responsive to the pre-screening inquiries, the interacting including capturing the voice-based response to the pre-screening inquiry of the lead request.

20. A non-transitory computer readable medium comprising instructions that, when executed by one or more processors of a computing device, cause the computing device to:
perform a feature identification of a received voice segment to recognize physical characteristics of the voice segment;
determine paralinguistic voice characteristics of the voice segment according to the physical characteristics of the voice segment; and
indicate a match status of the voice segment according to a comparison of the physical characteristics and the paralinguistic voice characteristics of the voice segment to desired characteristics of matching voice segments.

21. The medium of claim 20, further comprising instructions to cause the computing device to perform the feature identification by transforming the voice segment into data elements including one or more of (i) short-term Fast-Fourier Transform; (ii) frequency domain energy measure; and (iii) linear prediction coefficient in a frequency domain.

22. The medium of claim 20, wherein the physical characteristics include at least one of sound wave pattern, pitch, inflection, compression, and amplitude.

23. The medium of claim 20, wherein the paralinguistic voice characteristics include at least one of rate of speech, easiness to understand, and energy level.

24. The medium of claim 20, further comprising instructions to cause the computing device to:
maintain, in a database of structured voice data, associations of clusters of voice segment data that share similar physical characteristics to paralinguistic voice characteristics; and
determine the paralinguistic voice characteristics of the voice segment by retrieving associated paralinguistic voice characteristics of clusters of voice segment data that share similar physical characteristics to the physical characteristics of the voice segment.

25. The medium of claim 24, further comprising instructions to cause the computing device to train the database of structured voice data to map paralinguistic voice characteristics to predictive feature combinations of physical characteristics.

26. The medium of claim 24, further comprising instructions to cause the computing device to train the database of structured voice data according to identified paralinguistic voice characteristic input received from a training user interface.

27. The medium of claim 26, wherein the training user interface is provided to validator users by way of a web page in communication with the computing device.

28. The medium of claim 20, further comprising instructions to cause the computing device to:
receive, from a lead responder, a voice-based response to a pre-screening inquiry of a lead request, the voice-based response including the voice segment;
identify, from the voice segment, a textual answer to the pre-screening inquiry provided by the lead responder; and
score the lead responder as a potential lead in connection with the lead request based on the textual answer to the pre-screening inquiry and the match status of the voice segment.
